(19) United States
(12) Patent Application Publication
(10) Pub. No.: US 2026/0267017 A1
(43) Pub. Date: Sep. 10, 2026

(54) READOUT DESIGN FOR CHARGED PARTICLE COUNTING DETECTORS

(71) Applicant: ASML Netherlands B.V., Veldhoven (NL)

(72) Inventors: Yongxin WANG, San Ramon, CA (US); Steven Michael STUDULSKI, Sunnyvale, CA (US)

(73) Assignee: ASML Netherlands B.V., Veldhoven (NL)

(21) Appl. No.: 18/876,191

(22) PCT Filed: Aug. 24, 2023
(86) PCT No.: PCT/EP2023/073279

§ 371 Date: Dec. 18, 2024

Related U.S. Application Data
(60) Provisional application No. 63/408,755, filed on Sep. 21, 2022.

(51) Int. Cl. G01T 1/24; G01T 1/17

(52) U.S. Cl. CPC G01T 1/247; G01T 1/17

(57) ABSTRACT

A charged particle beam detector may include a plurality of sensing elements, each sensing element being connected to a dedicated array of signal detection cells. Each signal detection cell may include a solid state current controlling device configured to rapidly extract charge from the sensing element during a detection event. Each signal detection cell may further include a simplified architecture that automatically enables the next signal detection cell once a valid detection happens. The detection cell may store the detection signal until a controller is ready to read the signal out. Thus, each detection cell may be enabled in rapid succession to receive and store a signal with a simple and robust architecture.

### CROSS-REFERENCE TO RELATED APPLICATIONS

This application claims priority of U.S. application No. 63/408,755 which was filed on 21 Sep. 2022 and which is incorporated herein in its entirety by reference.

### FIELD

The description herein relates to detectors that may be useful in the field of charged particle beam systems, and more particularly, to systems and methods that may be applicable to charged particle detection using charged particle counting.

### BACKGROUND

Detectors may be used for sensing physically observable phenomena. For example, charged particle beam tools, such as electron microscopes, may comprise detectors that receive charged particles projected from a sample and that output detection signals. Detection signals may be used to reconstruct images of sample structures under inspection and may be used, for example, to reveal defects in the sample. Detection of defects in a sample is increasingly important in the manufacturing of semiconductor devices, which may include large numbers of densely packed, miniaturized integrated circuit (IC) components. Inspection systems may be provided for this purpose.

With continuing miniaturization of semiconductor devices, inspection systems may use lower and lower beam currents in charged particle beam tools. Existing detection systems may be limited by signal-to-noise ratio (SNR) and system throughput, particularly when beam current reduces to, for example, pico-ampere ranges. Electron counting has been proposed to enhance SNR and to increase throughput in electron beam inspection systems, wherein the intensity of an incoming electron beam is acquired by counting the number of electrons that reach the detector, and then analyzing the frequency of electron arrival events.

### SUMMARY

Embodiments of the present disclosure provide systems and methods for detection based on charged particle beams. A method according to embodiments of the present disclosure may comprise: enabling a first solid state current controlling device (SSCCD) of a first signal detection cell to be put into the on state in which the first SSCCD can conduct current from a charged particle sensing element of a charged particle counting detector; outputting a first current pulse from the charged particle sensing element in response to a first charged particle arriving at the charged particle sensing element, wherein the first current pulse triggers the first SSCCD to the on state. The method may further comprise, in response to the first SSCCD being triggered to the on state, conducting the first current pulse from an input to an output of the first SSCCD; and receiving a second enabling signal at a second signal detection cell comprising a second SSCCD, the second enabling signal being based on the first current pulse. The second enabling signal may enable the second SSCCD of the second signal detection cell to be put into the on state in which the second SSCCD can conduct current from the charged particle sensing element.

Some embodiments of the present disclosure may comprise a non-transitory computer-readable medium. The non-transitory computer-readable medium may store a set of instructions that is executable by at least one processor of an apparatus to cause the apparatus to perform the above method.

Some embodiments of the present disclosure provide a charged particle counting detector. The charged particle counting detector may comprise: a charged particle sensing element configured to output a first current pulse in response to a first charged particle arriving at the charged particle sensing element; a first signal detection cell comprising a first solid state current controlling device (SSCCD). The SSCCD may be configured: a) to be enabled, by a first enabling signal, to be put into an on state in which the first SSCCD can conduct current from the charged particle sensing element, b) to be triggered to the on state by the first current pulse, and c) to conduct the first current pulse to an output of the first SSCCD in response to the first SSCCD being triggered to the on state.

The charged particle counting detector may further comprise a second signal detection cell configured to receive a second enabling signal. The second signal detection cell may comprise a second SSCCD that is configured to be enabled, by the second enabling signal, to be put into an on state in which the second SSCCD can conduct current from the charged particle sensing element.

It is to be understood that both the foregoing general description and the following detailed description are exemplary and explanatory only and are not restrictive of the disclosed embodiments, as may be claimed.

### BRIEF DESCRIPTION OF THE DRAWINGS

The above and other aspects of the present disclosure will become more apparent from the description of exemplary embodiments, taken in conjunction with the accompanying drawings.

FIG. 1 is a diagrammatic representation of an exemplary electron beam inspection (EBI) system, consistent with embodiments of the present disclosure.

FIGS. 2A-B are diagrams illustrating a charged particle beam apparatus that may be an example of an electron beam tool, consistent with embodiments of the present disclosure.

FIGS. 3A-C are diagrammatic representations of an exemplary structure of a detector, consistent with embodiments of the present disclosure.

FIG. 4 is a diagrammatic representation of a circuit for charged particle counting.

FIG. 5 is a diagrammatic representation of a circuit for charged particle counting, consistent with embodiments of the present disclosure.

FIG. 6 is an example diagrammatic representation of an individual signal detection cell, consistent with embodiments of the present disclosure.

FIG. 7 is a diagrammatic representation of a circuit for charged particle counting, consistent with embodiments of the present disclosure.

FIG. 8 is an example diagrammatic representation of an individual signal detection cell, consistent with embodiments of the present disclosure.

FIGS. 9A-B are flowcharts illustrating methods that may be useful for electron counting, consistent with embodiments of the disclosure.

FIGS. 10A-B are flowcharts illustrating methods that may be useful for electron counting, consistent with embodiments of the disclosure.

FIGS. 11A-B are flowcharts illustrating methods that may be useful for electron counting, consistent with embodiments of the disclosure.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems, and methods consistent with aspects related to subject matter that may be recited in the appended claims. For example, although some embodiments are described in the context of utilizing charged-particle beams (e.g., electron beams), the disclosure is not so limited. Other types of charged particle beams (e.g., photon beams) may be similarly applied. Furthermore, other imaging systems may be used, such as optical imaging, photodetection, x-ray detection, or the like.

Electronic devices are constructed of circuits formed on a piece of silicon called a substrate. Many circuits may be formed together on the same piece of silicon and are called integrated circuits or ICs. With advancements in technology, the size of these circuits has decreased dramatically so that many more of them can fit on the substrate. For example, an IC chip in a smart phone can be as small as a fingernail and yet may include over 2 billion transistors, the size of each transistor being less than 1/1,000th the width of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process, that is, to improve the overall yield of the process.

One component of improving yield is monitoring the chip making process to ensure that it is producing a sufficient number of functional integrated circuits. One way to monitor the process is to inspect the chip circuit structures at various stages of their formation. Inspection can be carried out using a scanning charged-particle microscope (“SCPM”). For example, an SCPM may be a scanning electron microscope (SEM). A SEM can be used to image these extremely small structures, in effect, taking a “picture” of the structures. The image can be used to determine if the structure was formed properly and also if it was formed in the proper location. If the structure is defective, then the process can be adjusted so the defect is less likely to recur. To enhance throughput (e.g., the number of samples processed per hour), it is desirable to conduct inspection as quickly as possible.

The working principle of a SEM is similar to a camera. A camera takes a picture by receiving and recording intensity of light reflected or emitted from people or objects. A SEM takes a “picture” by receiving and recording energies or quantities of electrons reflected or emitted from the structures of the wafer. Before taking such a “picture,” an electron beam may be projected onto the structures, and when the electrons are reflected or emitted (“exiting”) from the structures (e.g., from the wafer surface, from the structures underneath the wafer surface, or both), a detector of the SEM may receive and record the energies or quantities of those electrons to generate an inspection image. To take such a “picture,” the electron beam may scan through the wafer (e.g., in a line-by-line or zig-zag manner), and the detector may receive exiting electrons coming from a region under electron-beam projection (referred to as a “beam spot”). The detector may receive and record exiting electrons from each beam spot one at a time and join the information recorded for all the beam spots to generate the inspection image. Some SEMs use a single electron beam (referred to as a “single-beam SEM”) to take a single “picture” to generate the inspection image, while some SEMs use multiple electron beams (referred to as a “multi-beam SEM”) to take multiple “sub-pictures” of the wafer in parallel and stitch them together to generate the inspection image. By using multiple electron beams, the SEM may provide more electron beams onto the structures for obtaining these multiple “sub-pictures,” resulting in more electrons exiting from the structures. Accordingly, the detector may receive more exiting electrons simultaneously and generate inspection images of the structures of the wafer with higher efficiency and faster speed.

Typically, the detection process involves measuring the magnitude of an electrical signal generated when electrons land on the detector. In another approach, electron counting may be used, in which a detector may count individual electron arrival events as they occur. In either approach, intensity of the secondary beam may be determined based on electrical signals generated in the detector that vary in proportion to the change in intensity of the secondary beam. Using electron counting, however, the discrete numbers of electrons that reach the detector from a secondary electron beam may be determined, and detection results may be output in digital form. The intensity of the beam may be determined by analyzing how frequently electron arrival events occur.

Electron counting may be helpful to improve signal-to-noise ratio (SNR) and throughput of a charged particle beam system. SNR may be a concern especially at low levels of primary beam current. Thus, electron counting may be an attractive method in applications such as metrology and overlay inspection where beam current is usually low. Electron counting may also be useful in separating signals generated by different types of electrons (e.g., secondary electrons and backscattered electrons). In some applications, it may be desirable to generate SEM images based purely or primarily on secondary electrons, based purely or primarily on backscattered electrons, or based on a combination.

Electron counting requires each electron reception on a detector surface to be detected individually, which can impose extreme requirements on the precision and speed of detector circuitry. For example, the surface of an electron counting detector might be subdivided into a large grid of tiny sensing elements, each one having its own dedicated signal processing circuits. This arrangement may allow electrons to land at different locations all over a detector surface at the same time while still being detected individually.

Yet even within these subdivisions, each detection signal is processed very rapidly in order to reset the circuitry before another electron strikes. There may not be enough time between two electron receptions for a circuit to process the signal. So, each sensing element may be connected to a number of identical detection circuits, which may be referred to as detection cells. When one detection cell receives a signal from an electron reception, it may begin signal processing while the next cell connects to the sensing element to await the next electron reception. This way, in theory, there should always be a detection cell ready and waiting to process an electron detection signal at each sensing element.

However, it can be complex and expensive to provide a circuit architecture that can rapidly select and control all these different detection cells in real time. Increased complexity leads to increased costs, power consumption, and higher risks of system failure. Furthermore, there is an upper limit to the speed that is achievable when using control circuitry that actively selects each detection cell in rapid succession at the sensing element level.

Embodiments of the present disclosure may provide a sensing element level circuitry that is simple, cost effective, fast, and robust to malfunction and system failure. The circuitry may be arranged such that each detection cell automatically performs many tasks that may otherwise require active control. For example, once a detection cell is enabled, it may be configured to turn its signal detection components on when a signal is received and shut itself down after the signal ends. The detection cell may be configured to automatically generate a signal to notify a controller that a detection has been achieved and store the detection signal until a controller is ready to read it. The signal detection cell may include components, such as a solid state current controlling device (SSCCD), that are designed to rapidly extract an electrical signal from the sensing element. The detection cells may also be structured to automatically pass an enabling signal to the next detection cell in line so that it can become enabled without any direct command from a controller. In this way, a simplified control architecture may reduce costs and increase signal processing speed.

Objects and advantages of the disclosure may be realized by the elements and combinations as set forth in the embodiments discussed herein. However, embodiments of the present disclosure are not necessarily required to achieve such exemplary objects or advantages, and some embodiments may not achieve any of the stated objects or advantages.

Without limiting the scope of the present disclosure, some embodiments may be described in the context of providing detection systems and detection methods in systems utilizing electron beams (“e-beams”). However, the disclosure is not so limited. Other types of charged particle beams (such as proton beams) may be similarly applied. Furthermore, systems and methods for detection may be used in other imaging systems, such as optical imaging, photon detection, proton detection, x-ray detection, ion detection, or the like. Photon detection may comprise light in the infrared, visible, UV, DUV, EUV, x-ray, or any other wavelength range. Therefore, while detectors in the present disclosure may be disclosed with respect to electron detection, some embodiments of the present disclosure may be directed to detecting other charged particles or photons.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C.

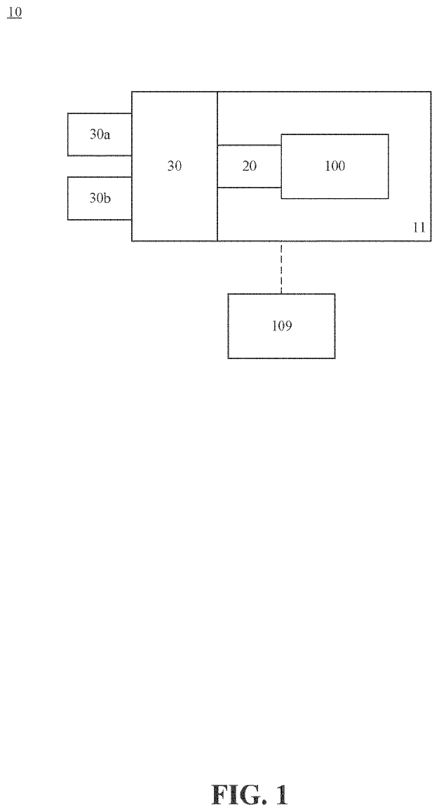

Reference is now made to FIG. 1, which illustrates an exemplary electron beam inspection (EBI) system 10 that may be used for wafer inspection, consistent with embodiments of the present disclosure. As shown in FIG. 1, EBI system 10 includes a main chamber 11 a load/lock chamber 20, an electron beam tool 100 (e.g., a scanning electron microscope (SEM)), and an equipment front end module (EFEM) 30. Electron beam tool 100 is located within main chamber 11 and may be used for imaging. EFEM 30 includes a first loading port 30a and a second loading port 30b. EFEM 30 may include additional loading ports. First loading port 30a and second loading port 30b receive wafer front opening unified pods (FOUPs) that contain wafers (e.g., semiconductor wafers or wafers made of other materials) or samples to be inspected (wafers and samples may be collectively referred to as “wafers” herein).

One or more robotic arms (not shown) in EFEM 30 may transport the wafers to load/lock chamber 20. Load/lock chamber 20 is connected to a load/lock vacuum pump system (not shown) which removes gas molecules in load/lock chamber 20 to reach a first pressure below the atmospheric pressure. After reaching the first pressure, one or more robotic arms (not shown) may transport the wafer from load/lock chamber 20 to main chamber 11. Main chamber 11 is connected to a main chamber vacuum pump system (not shown) which removes gas molecules in main chamber 11 to reach a second pressure below the first pressure. After reaching the second pressure, the wafer is subject to inspection by electron beam tool 100. Electron beam tool 100 may be a single-beam system or a multi-beam system. A controller 109 is electronically connected to electron beam tool 100, and may be electronically connected to other components as well. Controller 109 may be a computer configured to execute various controls of EBI system 10. While controller 109 is shown in FIG. 1 as being outside of the structure that includes main chamber 11, load/lock chamber 20, and EFEM 30, it is appreciated that controller 109 can be part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (or “apps”) for specific tasks. The memory may also be a virtual memory that includes one or more memories distributed across multiple machines or devices coupled via a network.

A charged particle beam microscope, such as that formed by or which may be included in EBI system 10, may be capable of resolution down to, e.g., the nanometer scale, and may serve as a practical tool for inspecting IC components on wafers. With an e-beam system, electrons of a primary electron beam may be focused at probe spots on a wafer under inspection. The interactions of the primary electrons with the wafer may result in secondary particle beams being formed. The secondary particle beams may comprise backscattered electrons, secondary electrons, or Auger electrons, etc. resulting from the interactions of the primary electrons with the wafer. Characteristics of the secondary particle beams (e.g., intensity) may vary based on the properties of the internal or external structures or materials of the wafer, and thus may indicate whether the wafer includes defects.

The intensity of the secondary particle beams may be determined using a detector. The secondary particle beams may form beam spots on a surface of the detector. The detector may generate electrical signals (e.g., a current, a charge, a voltage, etc.) that represent intensity of the detected secondary particle beams. The electrical signals may be measured with measurement circuitries which may include further components (e.g., analog-to-digital converters) to obtain a distribution of the detected electrons. The electron distribution data collected during a detection time window, in combination with corresponding scan path data of the primary electron beam incident on the wafer surface, may be used to reconstruct images of the wafer structures or materials under inspection. The reconstructed images may be used to reveal various features of the internal or external structures or materials of the wafer and may be used to reveal defects that may exist in the wafer.

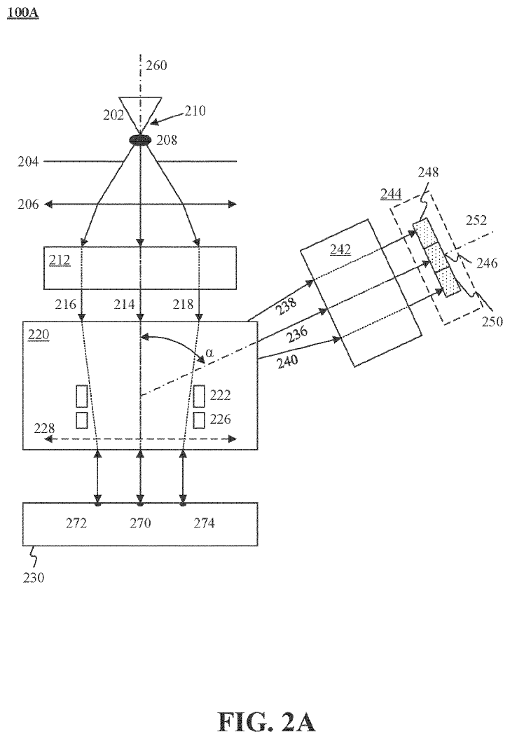

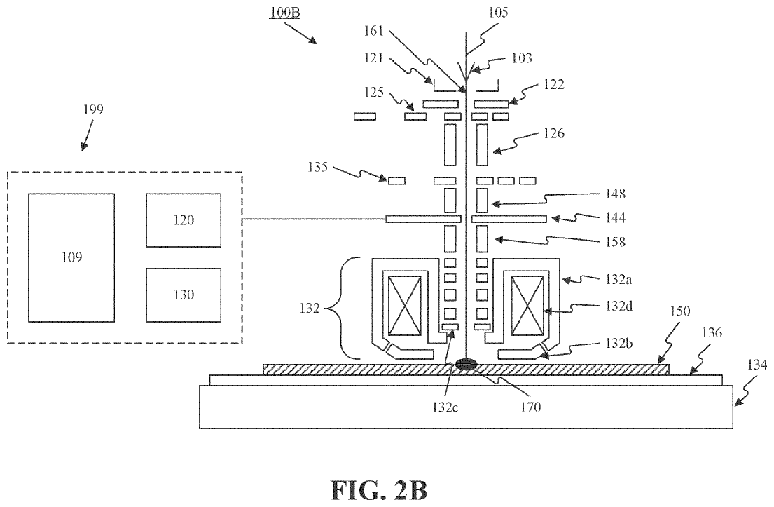

FIG. 2A illustrates a charged particle beam apparatus that may be an example of electron beam tool 100, consistent with embodiments of the present disclosure. FIG. 2A shows an apparatus that uses a plurality of beamlets formed from a primary electron beam to simultaneously scan multiple locations on a wafer.

As shown in FIG. 2A, electron beam tool 100A may comprise an electron source 202, a gun aperture 204, a condenser lens 206, a primary electron beam 210 emitted from electron source 202, a source conversion unit 212, a plurality of beamlets 214, 216, and 218 of primary electron beam 210, a primary projection optical system 220, a wafer stage (not shown in FIG. 2A), multiple secondary electron beams 236, 238, and 240, a secondary optical system 242, and electron detection device 244. Electron source 202 may generate primary particles, such as electrons of primary electron beam 210. A controller, image processing system, and the like may be coupled to electron detection device 244. Primary projection optical system 220 may comprise beam separator 222, deflection scanning unit 226, and objective lens 228. Electron detection device 244 may comprise detection sub-regions 246, 248, and 250.

Electron source 202, gun aperture 204, condenser lens 206, source conversion unit 212, beam separator 222, deflection scanning unit 226, and objective lens 228 may be aligned with a primary optical axis 260 of apparatus 100A. Secondary optical system 242 and electron detection device 244 may be aligned with a secondary optical axis 252 of apparatus 100A.

Electron source 202 may comprise a cathode, an extractor or an anode, wherein primary electrons can be emitted from the cathode and extracted or accelerated to form a primary electron beam 210 with a crossover (virtual or real) 208. Primary electron beam 210 can be visualized as being emitted from crossover 208. Gun aperture 204 may block off peripheral electrons of primary electron beam 210 to reduce size of probe spots 270, 272, and 274.

Source conversion unit 212 may comprise an array of image-forming elements (not shown in FIG. 2A) and an array of beam-limit apertures (not shown in FIG. 2A). An example of source conversion unit 212 may be found in U.S. Pat. No. 9,691,586; U.S. Publication No. 2017/0025243; and International Application No. PCT/EP2017/084429, all of which are incorporated by reference in their entireties. The array of image-forming elements may comprise an array of micro-deflectors or micro-lenses. The array of image-forming elements may form a plurality of parallel images (virtual or real) of crossover 208 with a plurality of beamlets 214, 216, and 218 of primary electron beam 210. The array of beam-limit apertures may limit the plurality of beamlets 214, 216, and 218.

Condenser lens 206 may focus primary electron beam 210. The electric currents of beamlets 214, 216, and 218 downstream of source conversion unit 212 may be varied by adjusting the focusing power of condenser lens 206 or by changing the radial sizes of the corresponding beam-limit apertures within the array of beam-limit apertures. Condenser lens 206 may be an adjustable condenser lens that may be configured so that the position of its first principal plane is movable. The adjustable condenser lens may be configured to be magnetic, which may result in off-axis beamlets 216 and 218 landing on the beamlet-limit apertures with rotation angles. The rotation angles change with the focusing power and the position of the first principal plane of the adjustable condenser lens. In some embodiments, the adjustable condenser lens may be an adjustable anti-rotation condenser lens, which involves an anti-rotation lens with a movable first principal plane. An example of an adjustable condenser lens is further described in U.S. Publication No. 2017/0025241, which is incorporated by reference in its entirety.

Objective lens 228 may focus beamlets 214, 216, and 218 onto a wafer 230 for inspection and may form a plurality of probe spots 270, 272, and 274 on the surface of wafer 230. Secondary electron beamlets 236, 238, and 240 may be formed that are emitted from wafer 230 and travel back toward beam separator 222.

Beam separator 222 may be a beam separator of Wien filter type generating an electrostatic dipole field and a magnetic dipole field. In some embodiments, if they are applied, the force exerted by electrostatic dipole field on an electron of beamlets 214, 216, and 218 may be equal in magnitude and opposite in direction to the force exerted on the electron by magnetic dipole field. Beamlets 214, 216, and 218 can therefore pass straight through beam separator 222 with zero deflection angle. However, the total dispersion of beamlets 214, 216, and 218 generated by beam separator 222 may also be non-zero. Beam separator 222 may separate secondary electron beams 236, 238, and 240 from beamlets 214, 216, and 218 and direct secondary electron beams 236, 238, and 240 towards secondary optical system 242.

Deflection scanning unit 226 may deflect beamlets 214, 216, and 218 to scan probe spots 270, 272, and 274 over an area on a surface of wafer 230. In response to incidence of beamlets 214, 216, and 218 at probe spots 270, 272, and 274, secondary electron beams 236, 238, and 240 may be emitted from wafer 230. Secondary electron beams 236, 238, and 240 may comprise electrons with a distribution of energies including secondary electrons and backscattered electrons. Secondary optical system 242 may focus secondary electron beams 236, 238, and 240 onto detection sub-regions 246, 248, and 250 of electron detection device 244. Detection sub-regions 246, 248, and 250 may be configured to detect corresponding secondary electron beams 236, 238, and 240 and generate corresponding signals used to reconstruct an image of the surface of wafer 230.

The generated signals may represent intensities of secondary electron beams 236, 238, and 240 and may be provided to an image processing system (e.g. such as image processing system 199 provided in FIG. 2B below) that is in communication with detection device 244, primary projection optical system 220, and motorized wafer stage. The movement speed of motorized wafer stage may be synchronized and coordinated with the beam deflections controlled by deflection scanning unit 226, such that the movement of the scan probe spots (e.g., scan probe spots 270, 272, and 274) may orderly cover regions of interests on the wafer 230. The parameters of such synchronization and coordination may be adjusted to adapt to different materials of wafer 230. For example, different materials of wafer 230 may have different resistance-capacitance characteristics that may cause different signal sensitivities to the movement of the scan probe spots.

The intensity of secondary electron beams 236, 238, and 240 may vary according to the external or internal structure of wafer 230, and thus may indicate whether wafer 230 includes defects. Moreover, as discussed above, beamlets 214, 216, and 218 may be projected onto different locations of the top surface of wafer 230, or different sides of local structures of wafer 230, to generate secondary electron beams 236, 238, and 240 that may have different intensities. Therefore, by mapping the intensity of secondary electron beams 236, 238, and 240 with the areas of wafer 230, the image processing system may reconstruct an image that reflects the characteristics of internal or external structures of wafer 230.

Detection sub-regions 246, 248, and 250 may include separate detector packages, separate sensing elements, or separate regions of an array detector. In some embodiments, each detection sub-region may include a single sensing element.

Another example of a charged particle beam apparatus will now be discussed with reference to FIG. 2B. An electron beam tool 100B (also referred to herein as apparatus 100B) may be an example of electron beam tool 100 and may be similar to electron beam tool 100A shown in FIG. 2A. However, different from apparatus 100A, apparatus 100B may be a single-beam tool that uses only one primary electron beam to scan one location on the wafer at a time.

As shown in FIG. 2B, apparatus 100B includes a wafer holder 136 supported by motorized stage 134 to hold a wafer 150 to be inspected. Electron beam tool 100B includes an electron emitter, which may comprise a cathode 103, an anode 121, and a gun aperture 122. Electron beam tool 100B further includes a beam limit aperture 125, a condenser lens 126, a column aperture 135, an objective lens assembly 132, and a detector 144. Objective lens assembly 132, in some embodiments, may be a modified SORIL lens, which includes a pole piece 132a, a control electrode 132b, a deflector 132c, and an exciting coil 132d. In a detection or imaging process, an electron beam 161 emanating from the tip of cathode 103 may be accelerated by anode 121 voltage, pass through gun aperture 122, beam limit aperture 125, condenser lens 126, and be focused into a probe spot 170 by the modified SORIL lens and impinge onto the surface of wafer 150. Probe spot 170 may be scanned across the surface of wafer 150 by a deflector, such as deflector 132c or other deflectors in the SORIL lens. Secondary or scattered particles, such as secondary electrons or scattered primary electrons emanated from the wafer surface may be collected by detector 144 to determine intensity of the beam and so that an image of an area of interest on wafer 150 may be reconstructed.

There may also be provided an image processing system 199 that includes an image acquirer 120, a storage 130, and controller 109. Image acquirer 120 may comprise one or more processors. For example, image acquirer 120 may comprise a computer, server, mainframe host, terminals, personal computer, any kind of mobile computing devices, and the like, or a combination thereof. Image acquirer 120 may be communicatively coupled with detector 144 of electron beam tool 100B through a medium such as an electrical conductor, optical fiber cable, portable storage media, IR, Bluetooth, internet, wireless network, wireless radio, or a combination thereof. Image acquirer 120 may receive a signal from detector 144 and may construct an image. Image acquirer 120 may thus acquire images of wafer 150. Image acquirer 120 may also perform various post-processing functions, such as image averaging, generating contours, superimposing indicators on an acquired image, and the like. Image acquirer 120 may be configured to perform adjustments of brightness and contrast, etc. of acquired images. Storage 130 may be a storage medium such as a hard disk, random access memory (RAM), cloud storage, other types of computer readable memory, and the like. Storage 130 may be coupled with image acquirer 120 and may be used for saving scanned raw image data as original images, and post-processed images. Image acquirer 120 and storage 130 may be connected to controller 109. In some embodiments, image acquirer 120, storage 130, and controller 109 may be integrated together as one electronic control unit.

In some embodiments, image acquirer 120 may acquire one or more images of a sample based on an imaging signal received from detector 144. An imaging signal may correspond to a scanning operation for conducting charged particle imaging. An acquired image may be a single image comprising a plurality of imaging areas that may contain various features of wafer 150. The single image may be stored in storage 130. Imaging may be performed on the basis of imaging frames.

The condenser and illumination optics of the electron beam tool may comprise or be supplemented by electromagnetic quadrupole electron lenses. For example, as shown in FIG. 2B, electron beam tool 100B may comprise a first quadrupole lens 148 and a second quadrupole lens 158. In some embodiments, the quadrupole lenses may be used for controlling the electron beam. For example, first quadrupole lens 148 may be controlled to adjust the beam current and second quadrupole lens 158 may be controlled to adjust the beam spot size and beam shape.

FIG. 2B illustrates a charged particle beam apparatus that may use a single primary beam configured to generate secondary electrons by interacting with wafer 150. Detector 144 may be placed along optical axis 105, as in the embodiment shown in FIG. 2B. The primary electron beam may be configured to travel along optical axis 105. Accordingly, detector 144 may include a hole at its center so that the primary electron beam may pass through to reach wafer 150. FIG. 2B shows an example of detector 144 having an opening at its center. However, some embodiments may use a detector placed off-axis relative to the optical axis along which the primary electron beam travels. For example, as in the embodiment shown in FIG. 2A, discussed above, a beam separator 222 may be provided to direct secondary electron beams toward a detector placed off-axis. Beam separator 222 may be configured to divert secondary electron beams by an angle a toward an electron detection device 244, as shown in FIG. 2A.

A detector in a charged particle beam system may include one or more sensing elements. The detector may comprise a single-element detector or an array with multiple sensing elements. The sensing elements may be configured for charged particle counting. Sensing elements of a detector that may be useful for charged particle counting are discussed in U.S. Publication No. 2019/0379682, which is incorporated by reference in its entirety.

Sensing elements may include a diode or an element similar to a diode that may convert incident energy into a measurable signal. For example, sensing elements in a detector may include a PIN diode. Throughout this disclosure, sensing elements may be represented as a diode, for example in the figures, although sensing elements or other components may deviate from ideal circuit behavior of electrical elements such as diodes, resistors, capacitors, etc.

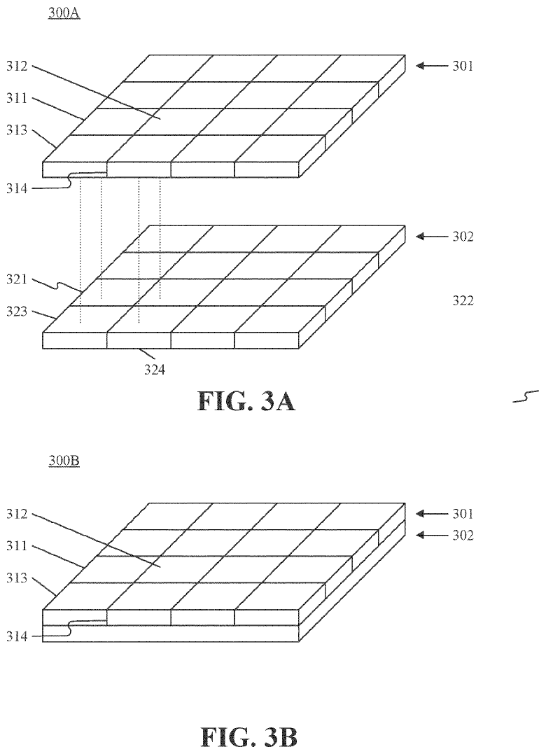

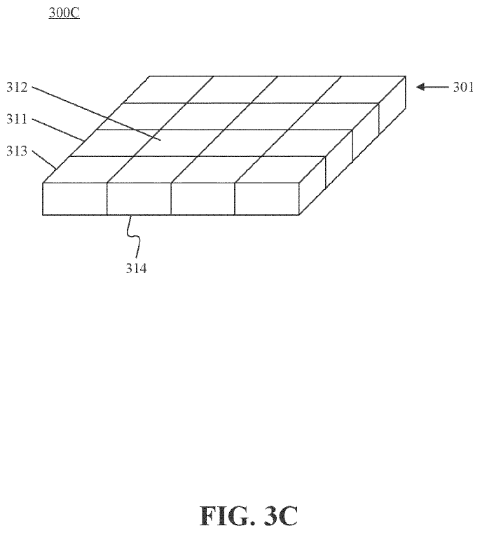

FIGS. 3A-C illustrate exemplary structures of a detector, consistent with embodiments of the present disclosure. The detector may be a segmented detector. A detector such as detector 300A, detector 300B, or detector 300C as shown in FIGS. 3A-C may be provided as charged-particle detection device 244 as shown in FIG. 2A or detector 144 as shown in FIG. 2B. In FIG. 3A, detector 300A includes a sensor layer 301 and a signal processing layer 302. Sensor layer 301 may include a sensor die made up of multiple sensing elements, including sensing elements 311, 312, 313, and 314. In some embodiments, the multiple sensing elements may be provided in an array of sensing elements, each of which may have a uniform size, shape, and arrangement.

Signal processing layer 302 may include multiple signal processing circuits, including circuits 321, 322, 323, and 324. The circuits may include interconnections (e.g., wiring paths) configured to communicatively couple sensing elements. Each sensing element of sensor layer 301 may have a corresponding signal processing circuit in signal processing layer 302. Sensing elements and their corresponding circuits may be configured to operate independently. As shown in FIG. 3A, circuits 321, 322, 323, and 324 may be configured to communicatively couple to outputs of sensing elements 311, 312, 313, and 314, respectively, as shown by the four dashed lines between sensor layer 301 and signal processing layer 302.

In some embodiments, signal processing layer 302 may be configured as a single die with multiple circuits provided thereon. Sensor layer 301 and signal processing layer 302 may be in direct contact. For example, as shown in FIG. 3B, which shows detector 300B, signal processing layer 302 directly abut sensor layer 301.

In some embodiments, components and functionality of different layers may be combined or omitted. For example, signal processing layer 302 may be combined with sensor layer 301. Furthermore, a circuit for charged particle counting may be integrated at various points in a detector, for example in a separate read-out layer of a detector or on a separate chip.

As shown in FIG. 3C, a detector 300C may be provided. Detector 300C may include sensor layer 301. Detector 300C may be configured for back-side illumination, and sensor layer 301 may be the only layer provided. A first side of sensor layer 301 may be configured to receive charged particles, and circuitry may be provided on a second side, opposite from the first side. The circuitry may include an electron counting circuit separately provided for each sensing element.

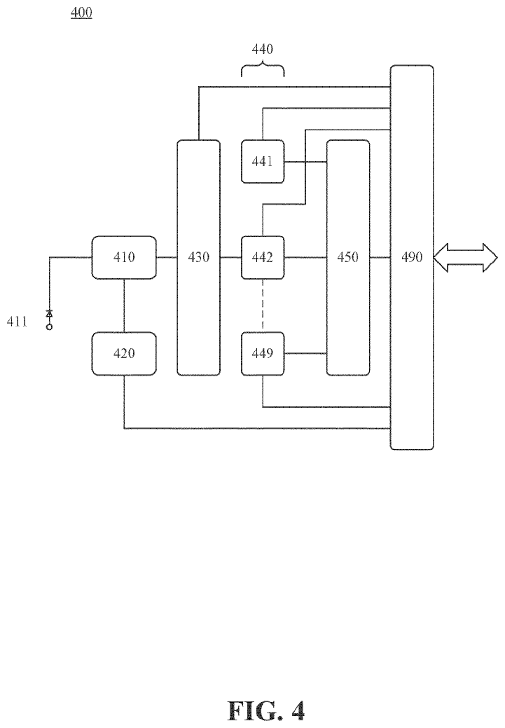

Reference is now made to FIG. 4, which illustrates a circuit 400 for charged particle counting. Circuit 400 may be one of a plurality of circuits, each of which is provided for a corresponding sensing element in an array detector. The detector may include only one sensing element, and only one circuit 400 may be provided. Alternatively, circuit 400 may be provided in a layer where sensing elements in a detector are formed (e.g., integrated with sensing elements), or in another layer. For example, circuit 400 may be provided in a sensor layer, or may be provided in another layer of a detector.

Circuit 400 may be configured to process signals generated from sensing element 411. Sensing element 411 may be configured to generate a response to a charged particle event. A charged particle event may include an electron arrival event. For example, in response to the arrival of an incoming electron at sensing element 411, sensing element 411 may be configured to generate charges or current due to the energy of the incoming electron. The charges or current may be generated within the sensing element and may be fed to circuitry connected to the sensing element. In some cases, the circuitry may be integrated with the sensing element.

As shown in FIG. 4, circuit 400 includes an input stage 410, a threshold detector 420, a storage cell multiplexer 430, an array 440 of storage cells, a converter 450, and a control unit 490. Array 440 may include a plurality of storage cells including a first storage cell 441, a second storage cell 442, and so on, up to, for example, an Nth storage cell 449. Storage cells 441 through 449 may include charge storage cells.

Input stage 410 may be configured to have a low input impedance such that all or substantially all charges are extracted from sensing element 411 quickly after they are generated in sensing element 411. Sensing element 411 may be configured to operate with a bias applied such that a depletion region is formed in sensing element 411 that may act as a capture region for incoming charged particles. Incoming charged particles may interact with the material of sensing element 411 and may generate charges through impact ionization. Input stage 410 may be configured such that all charges are pulled out from sensing element 411 as soon as they are generated in sensing element 411 and fed on to other components of circuit 400.

Input stage 410 may include a component configured to impart gain. For example, input stage 410 may include an amplifier. The amplifier may be configured to impart current gain such that current signal from sensing element 411 may be amplified. Furthermore, input stage 410 may be configured to have a conversion function. Input stage 410 may include a component configured to convert electrical signals from one form to another. For example, input stage 410 may include a component configured to convert current signal from sensing element 411 to an electronic signal of another form (e.g., a voltage).

Circuit 400 may include threshold detector 420. Threshold detector 420 may be attached to input stage 410. Threshold detector 420 may be configured to detect signal level of incoming current from sensing element 411 or that of a converted signal. The converted signal may include a signal having a level that is proportional to the incoming current from sensing element 411.

Threshold detector 420 may be configured to determine that a charged particle event occurs. Determinations from threshold detector 420 may be used to control other operations of circuit 400. Threshold detector 420 may be configured so as to detect a start or a stop of a charged particle event. The starting or stopping of a charged particle event may trigger the recording of information from sensing element 411. For example, an integration function may be performed in response to determining that a charged particle event occurs. Integration may refer to a process of obtaining an accumulated value of charge or current over time (e.g., area under a curve).

Threshold detector 420 may be configured to operate with one or more thresholds. For example, threshold detector 420 may be configured to use two values that may be defined and set in threshold detector 420. The two values may include a₁ and a₂ that may be the same or different from one another. Values of a₁ and a₂ may be set to be higher than an overall noise level of a detector. The noise level may be a noise floor from sensing element 411, its amplified value, or its converted value. A relationship between a₁ and a₂ may be, for example, a₁≥a₂. Thresholds may be set so as to avoid false detection of start or stop points of electron arrival events due to noise.

Circuit 400 may include storage cell multiplexer 430 following input stage 410. Input stage 410 may be optional, for example when a circuit for integration function is provided that has very low input impedance. Hereinafter, the phrase “output of input stage 410” may refer to the output of input stage 410 or the output of sensing element 411. The output of input stage 410 may represent output signal from sensing element 411, whether or not it is amplified or converted, for example.

Multiplexer 430 (or “mux”) may be configured to connect the output of input stage 410 to a storage cell of array 440. Multiplexer 430 may include a switching element. Multiplexer 430 may include a data selector that is configured to select between several output lines and forward an input signal to the selected output line. Multiplexer 430 may be configured to connect only one output line to the input at a time. For example, multiplexer 430 may be configured to route signals from the output of input stage 410 to only one of storage cell 441, 442, 449 at a time. Furthermore, multiplexer 430 may be configured so that the output of input stage 410 is connected to none of the storage cells of array 440 at a particular time during operation of circuit 400. Similarly, multiplexer 430 may be configured so that output of input stage 410 is connected to other components besides storage cells of array 440. Multiplexer 430 may be controlled by control unit 490.

Array 440 may include one or a plurality of storage cells. The outputs of individual storage cells may be connected to converter 450. Signals that are input to storage cells of array 440 may be converted to another form (e.g., through integration). As an example, current or charge input to storage cells of array 440 may accumulate to form a voltage signal. Converter 450 may be configured to sample the storage cells of array 440. Converter 450 may be configured to process analog signals from the storage cells of array 440 or analog signals passed to it from other sensing element circuits. Converter 450 may generate digital signals for data that represent the analog signals.

Converter 450 may include a voltage detector or analog-to-digital converter (ADC), for example. Converter 450 may include a comparator having multiple inputs that are connected directly to the storage cells of array 440. Converter 450 may include a single comparator that is connected to multiple inputs through a multiplexer.

Circuit 400 may be configured to perform interrogation (e.g., an interrogation function) on the storage cells of array 440 after integration in a storage cell is complete. Integration may refer to the accumulation of a signal from, e.g., sensing element 411 or input stage 410. Interrogation may refer to the obtaining of information from a component, for example, by using a data converter or comparators to determine a voltage value for determining, e.g., an energy level of an electron arrival event. Circuit 400 may be configured to detect (e.g., interrogate) only storage cells that are not selected by storage cell multiplexer 430. For example, interrogation may be performed on storage cells separately from integration so as not to interfere with integration.

Converter 450 may include one or more voltage comparators. The voltage comparators may be used to compare voltages from the storage cells of array 440 to reference voltages. The number of voltage comparators and the number of reference voltages may be the same or different. A voltage buffer may be provided. For example, a voltage buffer may be provided in front of the multiple voltage comparators to reduce the loading effects of input impedances of the voltage comparators on the voltages of the storage cells of array 440. Converter 450 may also include one or a group of ADCs, each with a predefined bit resolution.

Control unit 490 may be configured to perform various functions associated with circuit 400. For example, control unit 490 may be configured to: (i) control the operation of sensing element level circuitry, (ii) generate data based on the detection results of electron arrival events, (iii) communicate with a higher level control unit (not shown), and (iv) communicate with neighboring control units in neighboring sensing element level circuits that are similar or identical to, e.g., circuit 400. Control unit 490 may be configured for bidirectional data flow between itself and the neighboring control units of neighboring sensing element level circuits. The higher-level control unit may be configured for bidirectional data flow between itself and control unit 490, as well as between itself and the neighboring control units in the neighboring sensing element level circuits.

Circuit 400 may be configured to count charged particles incident on a detector. If the level of incoming current signal from sensing element 411 crosses a threshold, circuit 400 may be configured to start a counting operation. For example, if threshold detector 420 determines that a₁ is exceeded, integration may be performed. Control unit 490 may control storage cell multiplexer 430 to connect the output of input stage 410 to first storage cell 441. A capacitor in first storage cell 441 may be charged as current or charges from sensing element 411 accumulate. At the same time, voltages in one or more of the other storage cells (e.g., second storage cell 442 to Nth storage cell 449) that are not selected by storage cell multiplexer 430 may be detected by converter 450.

Converter 450 may be configured with different reference values that may be used for different purposes, for example as follows. Reference values may be used to confirm the arrival of incoming electrons. Reference values may be used to identify the types of incoming electrons (e.g., to determine whether an incoming electron is a secondary electron or a backscattered electron). Reference values may be used to determine whether there have been more than one electron arriving during an electron arrival event. Reference values may be used to determine whether the sensing element or a storage cell is in an overflow state due to an electron arrival event. Reference values may also be used to determine energy ranges of incoming electrons or the exact energy levels of incoming electrons.

As an example of a use of a reference value, if only one predefined reference voltage or predefined value (e.g., in a case where an ADC of one bit resolution is used) is set, the one reference value may be used to identify whether an incoming electron is a secondary electron or a backscattered electron at the time of an electron arrival event of which the result is stored in the storage cell under interrogation. Or, the reference value may be used to confirm that the electron arrival event has occurred (e.g., even after the threshold a₁ has been exceeded, thus signifying the start of an electron arrival event, the reference value of converter 450 may be used to confirm that the signal from sensing element 411 corresponds to the detection of a secondary or backscattered electron from a sample, and thus that the electron should be counted).

In a second scenario, one of the reference voltages or values may be used to identify the type of incoming electron during the electron arrival event; and the other reference voltage or value may be used to determine whether one or more than one electron reaches the sensing element during the electron arrival event.

In a third scenario, one of the reference voltages or values may be used to determine whether one or more than one electron reaches the sensing element during the electron arrival event; and the other reference voltage or value may be used to determine whether the storage cell is in an overflow state. The overflow state may correspond to a situation where there are more than two electrons reaching the sensing element during the electron arrival event.

It will be understood that more scenarios may be set up by combining different tasks, such as those discussed above. Further predefined voltages or values may be used based on requirements for specific applications. Furthermore, after information interrogation, a storage cell may be reset and information stored in the storage cell may be removed from the storage cell (e.g., the voltage across a capacitor in the storage cell may be reset to a predefined value, such as zero).

There may be a time period associated with an electron arrival event. The expression “during the electron arrival event,” for example as discussed above, may refer to a period based on when threshold detector 420 determines that signal from sensing element 411 crosses (e.g., exceeds) ai and when signal crosses (e.g., falls below) a₂. A predetermined period may be set such that an electron arrival event lasts for a maximum duration from when a₁ is exceeded until the end of the predetermined period. If, after a predetermined period, no stop point is detected (e.g., signal crossing the same or another threshold), counting for a given electron arrival event may be forced to stop. If there is no confirmed electron detected during an electron arrival event, a detection error signal may be generated and recorded by control unit 490.

Control unit 490 may be configured for further tasks. For example, when threshold detector 420 determines that a threshold has been crossed, various functions may be performed. When threshold detector 420 detects a start of an electron arrival event, control unit 490 may record the time stamp of the starting point. Control unit 490 may be configured to monitor whether a subsequent stop point is detected only if a start point is detected. For example, threshold detector 420 may not use second threshold a₂ unless or until first threshold ai has been crossed. Furthermore, a time stamp may also be recorded for stop points. The threshold associated with the start point may be higher than the threshold associated with the stop point. An event period may be determined based on start and stop points.

A first charged particle event may be detected when threshold detector 420 determines that signal from sensing element 411 exceeds a₁. Integration of the first charged particle event may be performed using first storage cell 441. After the first charged particle event, integration of a second charged particle event may be performed using a different storage cell (e.g., second storage cell 442). The term “after” the first charged particle event may refer to the case where signal from sensing element 411 drops below a₂. “After” the first charged particle event may refer to a case where a predetermined period of time passes from when threshold detector 420 has determined that signal from sensing element 411 exceeds a₁.

Integration and information interrogation may occur simultaneously. For example, while information interrogation is performed on a cell-by-cell basis, or in parallel with multiple cells that are not selected by storage cell multiplexer 430, circuit 400 may proceed with integration at the cell selected by storage cell multiplexer 430. Integration may cause signals from the output of input stage 410 to be transmitted to the selected storage cell of array 440. Integration may proceed until threshold detector 420 determines that signal from sensing element 411 falls below threshold a₂ (or a stop point is otherwise determined). In response to signal level falling below a₂, storage cell multiplexer 430 may break the connection between input stage 410 (or the output of an integration circuit) and the currently selected storage cell. Immediately thereafter, circuit 400 may connect the output of input stage 410 to another storage cell. The storage cell that is then connected may be a storage cell that has already been reset. Integration may then proceed again using the newly selected storage cell. Integration may not be started immediately upon connection to the new storage cell unless, for example, threshold detector 420 determines that a₁ is exceeded again.

Integration and interrogation may be ongoing when a detector is in operation. Integration results stored in storage cells may be interrogated and counting results may be sent to control unit 490. Such operations may occur at the sensing element level. Thus, for all sensing elements of a detector, separate integration and interrogation processes may be performed. Data may be processed and sent to an upper level control unit of the detector. The upper level control unit may be configured to determine electron counts based on data from lower level control units (e.g., control unit 490 at the sensing element level of a detector).

Control unit 490 may be configured to determine an overflow state (e.g., set an overflow flag) of a sensing element or storage cell. With regard to overflow, there may be several different types. Overflow is discussed in U.S. Publication No. 2019/0379682.

For example, overflow may include a first type of overflow. The first type of overflow may involve the level of signal relating to one charged particle event exceeding a predetermined value. The predetermined value may be a value determined based on a limit of a circuit associated with a sensing element. For example, the predetermined value may be a percentage of a processing limit of the circuit. The first type of overflow may correspond to cases where multiple charged particles arrive during one charged particle event. For example, multiple charged particles may arrive at a sensing element in such close succession, even substantially simultaneously, that signals from the multiple charged particle arrival events may strongly overlap in the time domain. The integration result from these multiple charged particle arrival events may be larger than circuit 400 is equipped to handle. Accordingly, the circuit may be configured record an overflow event in such circumstances by, e.g., setting an overflow flag indicating the first type of overflow.

The first type of overflow may be encountered when a component of a circuit connected to a sensing element is in an overflow state. For example, the first type of overflow may be encountered when a component of a circuit connected to a sensing element for counting charged particles in a specific energy range is in an overflow state. For example, the first type of overflow flag may be set when an interrogation result shows that the electron arrival event recorded by the storage cell involves more than a certain number of incoming electrons. The certain number may be one or two, for example. Whether the certain number is one or two may depend on requirements of particular applications and corresponding reference voltage (or value) setting scenarios. Furthermore, frequency of occurrence of the first type of overflow may be reduced if the dynamic range of the circuit is increased (e.g., the input stage, the storage multiplexer, the storage cell, and the convertor can operate under higher signal swing). Additionally, the first type of overflow may be reduced by increasing the capacitance of the storage cells or reducing the signal swing of the input stage. However, this may be at the expense of energy resolution loss.

Overflow may also include a second type of overflow. The second type of overflow may involve situations where during the signal detection and processing of one charged particle event, another charged particle event occurs. The second type of overflow may be encountered when one charged particle arrives at a sensing element and a subsequent charged particle arrives in a state where the sensing element and its associated circuitry are unable to give a proper response to the subsequent charged particle arrival event.

The second type of overflow may be indicated by a flag. The second type of overflow flag may be set when there is no available storage cell for storage cell multiplexer 430 to select. The second type of overflow may be avoidable if a large enough number of storage cells are provided. This may be based on the variety of reference voltages or values used in converter 450 and the operation speed of components in converter 450. The rate of the second type of overflow may be reduced with further enhancements in the speed of sensing element 411, input stage 410, threshold detector 420, storage cell multiplexer 430, and converter 450.

Using an overflow indication may be helpful to identify miscounting or erroneous detection of charged particle arrival events. Circuit 400 may be configured to use overflow tags to monitor a miscount rate at the storage cells 441 through 449. By indicating that detection information has been lost due to, e.g., type 1 or type 2 overflow, circuit 400 may provide more accurate results. For example, overflow information may be used to estimate a correction to the measurements to account for lost information, to assign a confidence weight to the measurements, or to provide a correction in the circuitry to prevent losses in subsequent measurements.

Circuit 400 may use an analog pipeline in a detection circuit and may provide a sufficient number of converters in a signal processing portion of the circuit to ensure that the overall processing rate of the detection circuit is higher than the average rate at which a sensing element generates signals in response to charged particle arrival event. This may reduce or avoid the second type of overflow. Further, a detector or charged particle beam apparatus may be configured so that the occurrence of the first type of overflow is reduced. The occurrence of the first type of overflow may be based on the speed of sensing elements generating signals in response to charged particle arrival events and the bandwidth of an analog front-end of the detection circuit. If probe current is increased beyond a certain level, the detection circuit may encounter the first type of overflow indicating the occurrence of an event with information loss. This may be due to the front-end of the detection circuit being unable to distinguish multiple charged particle arrival events, or it may be due to speed limitations in threshold detector 420, storage cell multiplexer 430, storage cell array 440, converter 450, or control unit 490. For example, multiple charged particles may arrive at a sensing element in close succession or at substantially the same time. To reduce the first type of overflow, the speed of sensing elements and bandwidth of front-ends may be increased. Alternatively or additionally, the charged particle optics may be tuned such that the intensity distribution of charged particles arriving on the detection surface is made more uniform and evenly spread over a larger area, thus covering more sensing elements.

Further discussion of electron counting circuitry may be found in International Application No. PCT/EP2021/068676, which is incorporated by reference in its entirety.

The analog pipeline and storage cell array architecture of FIG. 4 may be complex and costly to manufacture, especially for systems that do not need to utilize its energy-level discrimination capabilities. Increased complexity introduces an increased risk of malfunction. In addition to cost and risks of malfunction, the architecture may have an undesirably high power consumption within each sensing element level readout circuit.

Embodiments of the present disclosure provide a new sensing element level readout circuit design that improves upon the analog signal pipeline and storage cell array architecture above. The new design may be configured to accomplish all the functions of circuit 400 of the comparative embodiment of FIG. 4 using a streamlined and simplified circuit structure that is both robust and cost-effective. In addition, some embodiments may provide a further simplification when there is no need for an incoming electron energy level discrimination function. Therefore, some embodiments may greatly simplify the signal readout process into a pure electron counting operation. By using the sensing element readout circuit design of the present disclosure, both manufacturing costs and power consumption of the readout circuitry in an electron counting detector may be advantageously reduced.

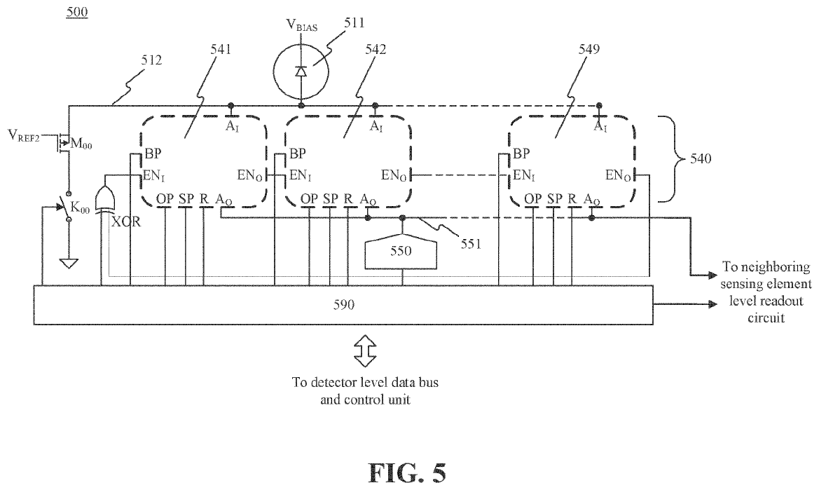

FIG. 5 illustrates a simplified block diagram of a sensing element level readout circuit design 500 with its corresponding sensing element 511, consistent with embodiments of the present disclosure. Sensing element 511 may correspond to, e.g., any of sensing elements 311-314 of FIGS. 3A-C. Sensing element 511 may be a charged particle sensing element configured to generate an electrical signal in response to a charged particle arrival event. The electrical signal may be, e.g., an electrical charge, current or voltage. In some embodiments, sensing element 511 may be a photon sensing element.

Circuit 500 may comprise an array 540 of signal detection cells, such as signal detection cells 541, 542, etc., up to 549. Signal detection cell 549 may be an Nth detection cell in the array. In other words, array 540 may generally comprise any number of signal detection cells, with signal detection cell 549 representing the final signal detection cell in array 540. Each signal detection cell may comprise a plurality of inputs and outputs. For example, each signal detection cell may comprise: analog signal input A_{I}; analog signal output A_{O}; enable signal input EN_{I}; enable signal output EN_{O}; bypass input BP; operation status output OP; sample control signal input SP; and reset signal input R.

Analog signal input A_{I} of the detection cell may be configured to receive an electrical signal from sensing element 511 via input bus 512, and to pass the electrical signal to internal circuitry (not shown in FIG. 5) configured to store the electrical signal. For example, the internal circuitry may comprise a storage capacitor. Analog signal output A_{O} may be configured to output a detection result signal from the signal detection cell to a converter 550 via analog signal bus 551 within the sensing element level circuit 500. Analog signal output A_{O} may comprise information about energy stored in the storage capacitor. Analog signal output A_{O} may output information used for energy level discrimination as well as, e.g., generating an overflow flag (such as a type 1 overflow tag).

Enable signal input EN_{I} may be configured to receive an enabling signal. Enable signal input EN_{I} may pass the enabling signal to internal circuitry (not shown in FIG. 5) that enables the signal detection cell. In an enabled state, for example, the internal circuitry of the signal detection cell may be configured to receive and store a signal from sensing element 511. Enable signal output EN_{O} may be configured to pass a further enabling signal to a further enable signal input ENI in a next signal detection cell in the array. For example, enable signal output EN_{O} of signal detection cell 541 may pass an enabling signal to the enable signal input EN_{I} of next signal detection cell 542. As further discussed below, a signal detection cell may receive an enabling signal via enable signal input EN_{I} when it is to be enabled, and may send an enabling signal via enable signal output EN_{O} when it is time to activate a next signal detection cell. For example, signal detection cell 541 may send an enabling signal via enable signal output EN_{O} to signal detection cell 542 after signal detection cell 541 has performed a signal detection, such as by receiving or storing an electrical signal from sensing element 511, or by generating an output at analog signal output A_{O}. Signal detection cell 541 may be in an inactive state after sending the enabling signal via enable signal output EN_{O} to activate further signal detection cell 542. In the inactive state, signal detection cell 541 may not be configured to receive further charge from sensing element 511. However, signal detection cell 541 may perform other functions, such as storing charge or generating output signals, in the inactive state.

Signal detection cell bypass input BP may be configured to receive a bypass signal and activate bypass circuitry (not shown in FIG. 5) of its signal detection cell. For example, when bypass circuitry is activated, the signal detection cell may be placed in a bypass state. In the bypass state, the signal detection cell may not be configured for signal detection. For example, the signal detection cell may not be configured to receive or store charge from sensing element 511 in the bypass state. The signal detection cell may be configured to pass any enabling signal to a next signal detection cell instead of using the enabling signal to activate its own circuitry.

A signal detection cell may be bypassed, e.g., if it is not functioning properly or if fewer signal detection cells are desired. For example, when the frequency of electron arrival events is low enough that not all signal detection cells are needed, it may be desirable to bypass unnecessary signal detection cells to isolate their circuitry, minimize parasitic parameters and reduce power consumption. Additionally, the bypass function may be used when a signal detection cell has detected and stored a signal from an electron arrival event, but the signal has not yet been processed by signal processing circuitry. In this case, the signal detection cell may remain inactive until its signal has been processed.

Operation status output OP may be configured to output an operation status signal to a control unit 590. The operation status output may, e.g., comprise information about an operational state of the signal detection cell. For example, an operation status signal may comprise information about whether its signal detection cell is in an enabled state, an inactive state, a bypassed state, or another operational state. In some embodiments, operation status output OP may output information about whether its signal detection cell is currently storing charge, or may output information used in electron counting, as further discussed below.

Sample control signal input SP may be configured to receive a sample control signal from control unit 590. The sample control signal may cause internal circuitry (not shown) to control whether an analog signal captured by the signal detection cell is output by analog signal output A_{O} to converter 550 via analog signal bus 551.

Reset signal input R may be configured to receive a reset signal from control unit 590. The reset signal may cause internal circuitry (not shown) to reset the signal detection cell to an initial state. For example, the initial state may be an inactive state in which the signal detection cell is ready to be enabled by an enabling signal at enable signal input EN_{I}. Resetting the signal detection cell to an initial state may comprise, e.g., discharging any charge stored within the signal detection cell, such as in a storage capacitor.

Transistor M₀₀ and switch K₀₀ may form a charge release path from sensing element 511 to ground G. For example, switch K₀₀ may be, e.g., an analog switch configured to selectively pass or block the flow of charge to ground G based on a control signal from control unit 590. Circuit element M₀₀ may be optionally included, e.g., as a current or voltage buffer. Circuit element M₀₀ may be, e.g., a MOSFET configured as a common gate amplifier having a reference voltage V_{ref2}. When sensing element 511 is not in use, switch K₀₀ may be closed so that charges generated at sensing element 511 may be passed to ground G and do not accumulate in the sensing element.

Logic gate XOR may be configured, e.g., as an XOR or other logic gate device. Logic gate XOR may be configured to activate a first signal detection cell 541 in array 540 based on a left input from control unit 590 and a right input from enable signal output EN_{O} of final signal detection cell 549 in array 540. For example, logic gate XOR may be configured to receive a binary signal, represented by 0 or 1, at each of the left and right inputs seen in FIG. 5. Logic gate XOR may be configured to output a signal value of 1 only when its inputs are dissimilar. For example, when a left input and right input are both 1 or both 0, logic gate XOR may not output a signal value of 1. However, when a first input is 1 and the other input is 0, logic gate XOR may be configured to output a signal value of 1. Logic gate XOR may be used to initiate and repeat a cycle of signal detections in array 540 as further discussed below. Logic gate XOR may be part of control unit 590.

Converter 550 may receive analog signals from signal detection cells 541-549 via analog signal bus 551 and convert them to digital signals. Alternatively, converter 550 may receive signals from neighboring signal detection cells of a neighboring sensing element via analog signal bus 551. Converter 550 may be similar to, e.g., converter 450 of FIG. 4. For example, converter 550 may include a voltage detector or analog-to-digital converter (ADC). Converter 550 may include a comparator having multiple inputs that are connected directly to converter 550. Converter 550 may include a single comparator that is connected to multiple inputs through a multiplexer. Converter 550 may be part of control unit 590.

Control unit 590 may be configured for bidirectional data flow. Control unit 590 may be configured for various functions and may be similar to, e.g., control unit 490 of FIG. 4. Control unit 590 may be configured to control sensing element 511 and signal detection cells 541-549. Control unit 590 may be configured to receive and process inputs from the outputs of signal detection cells. For example, control unit 590 may be configured to receive operation status signals from operation status output OP, and digital signals from converter 550, including converted analog signals from analog signal output A_{O}. Control unit 590 may be configured to generate and send output signals to the inputs of signal detection cells. For example, control unit 590 may be configured to send signal detection cell bypass signals to bypass BP, sample control signals to sample control signal input SP, and reset signal to reset signal input R. Control unit 590 may comprise further inputs and outputs not illustrated here. For example, further inputs and outputs may functionally couple control unit 590 to sensing element 511, detector-level data and control circuitry, and other sensing element level readout circuitry of neighboring sensing elements.

A detection operation of circuit 500 of FIG. 5 is now described using the above inputs, outputs and other components, consistent with embodiments of the present disclosure. The operation may take place in a detector, such as electron detection device 244 of electron beam tool 100A of FIG. 2A, or electron detection device 144 of electron beam tool 100B of FIG. 2B. The detector may be part of, e.g., EBI system 10 of FIG. 1.

Alternatively, the operation may take place in another electron detector or another type of detector, such as a proton, photon or other detector. Therefore, while embodiments may discuss operations and elements in terms of electrons, it should be understood that other embodiments are possible.

When sensing element 511 is to be enabled for signal detection, control unit 590 may place sensing element 511 in a sensing state. For example, control unit 590 may open switch K₀₀ to disconnect sensing element 511 from ground G. Control unit may further output a signal value of 1 to the left input of logic gate XOR. Because signal detection cell 549 is in an initial state, it is not presently outputting a signal value of 1 to the right input of logic gate XOR via enable signal output EN_{O}. Thus, enable signal output EN_{O} of signal detection cell 549 causes an output of a signal value of 0 (wherein a signal value of 0 may refer to no signal or to a binary signal value other than 1). Because the left and right inputs of logic XOR are dissimilar, logic gate XOR may output a signal value of 1 as an enabling signal to enable signal input EN_{I} of signal detection cell 541. Later when signal detection cell 541 transmits an enabling signal from enable signal output EN_{O} to the enable signal input EN_{I} of the next signal detection cell, such as detection cell 542, control unit 590 may cease outputting the signal value 1 to the left input of logic gate XOR, such that the left input is receiving a signal value of 0. For example, control unit 590 may determine that signal detection cell 541 has output the enabling signal based on an operating status output signal from operating status output OP of signal detection cell 541.

When enable signal input EN_{I} of signal detection cell 541 receives the enabling signal from logic gate XOR, the signal detection cell is enabled for receiving and storing charge from sensing element 511. All other signal detection cells in array 540 may remain in an inactive state, such as the initial state or a bypass state. Signal detection cell 541 may remain enabled, e.g., until it registers an electron detection. Alternatively, signal detection cell may remain enabled until it is disabled by control unit 590, such as by sending a reset signal to reset signal input R or a bypass signal to bypass input BP.

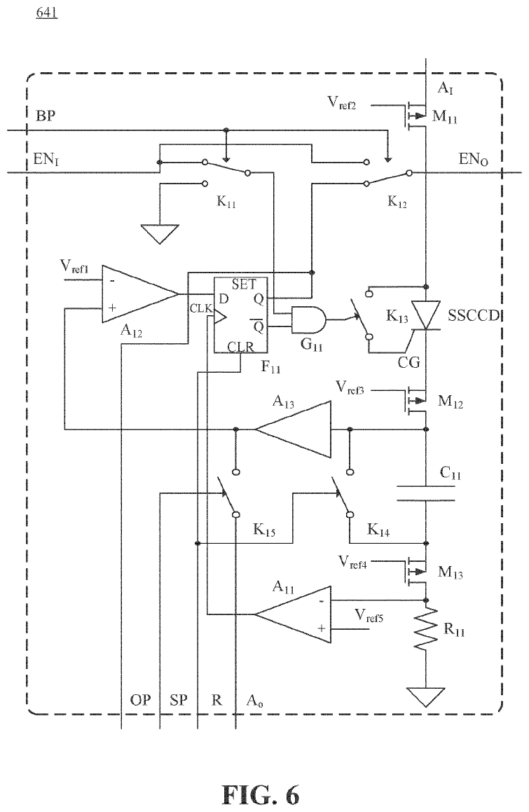

When an electron landing even occurs at sensing element 511, an analog signal may be generated and transmitted to analog signal input A_{I} of signal detection cell 541. Signal detection cell 541 may receive and store charge from the generated analog signal using, e.g., a solid-state current controlling device and storage capacitor (not shown) as further discussed below with respect to FIG. 6. In addition to storing charge, the reception of an analog signal may trigger the transmission of an enabling signal at enable signal output EN_{O} and an operation status signal at operation status output OP.

The operation status signal may indicate to control unit 590 that, e.g., an electron arrival event has been registered in signal detection cell 541. Control unit 590 may interrogate the detection cell by, e.g., outputting a sample control signal to sample control signal input SP. Based on the sample control signal, detection cell 541 may produce a detection result signal at analog signal output A_{O}. The detection result signal may be transmitted to converter 550 via analog signal bus 551. Alternatively, the detection result signal may be transmitted to, e.g., another converter at a neighboring sensing element. The detection result signal may comprise information about the electron detection. For example, the information may simply indicate that an electron arrival has occurred at sensing element 511, or it may comprise information about an energy level associated with the electron arrival.

After signal interrogating the signal, control unit 590 may output a reset signal to reset signal input R to return signal detection cell 541 to its initial inactive state. For example, the reset signal may cause switch K₁₄ to close, thereby shorting storage capacitor C₁₁ and draining any accumulated charge. and may reset the solid-state current controlling device SSCCD.

Before, after, or concurrently with the generation of the operation status signal, enable signal output EN_{O} of signal detection cell 541 may activate the next signal detection cell 542 by transmitting an enabling signal to enable signal input EN_{I} of signal detection cell 542. Alternatively, if signal detection cell 542 is in a bypass state, the enabling signal may pass directly through signal detection cell 542 and onto a next signal detection cell until the enabling signal reaches a signal detection cell that is not in a bypass state. After activating this next available signal detection cell, the process discussed above may be repeated.

The process may cycle through signal detection cells in array 540 until it reaches final detection cell 549. When final signal detection cell 549 outputs an enabling signal from its enable signal output EN_{O}, it may be transmitted as a signal value 1 to the right input of logic gate XOR. Because control unit has ceased delivery of the value 1 signal as discussed above, the left input receives a signal value of 0 the logic outputs a new enabling signal to enable signal input EN_{I} of first signal detection cell 541. In this way, array 540 of signal detection cells 541-549 may be cycled through repeatedly during a detection process.

The sensing element level readout circuit design 500 may provide a simple and cost-effective architecture configured to passively trigger the successive activation of a series of signal detection cells without requiring complex control circuitry to manage the process.

FIG. 6 illustrates a simplified diagram of an example of internal circuitry of a signal detection cell 641, consistent with some embodiments of the present disclosure. Signal detection cell 641 may be, e.g., one possible implementation of signal detection cells 541-549 of FIG. 5. The various circuit elements and other components of signal detection cell 641 will be discussed in turn.

Signal detection cell 641 may comprise three transistors M₁₁, M₁₂, and M₁₃. The transistors may be, e.g., MOSFET or other transistors and may be configured as, e.g., common gate amplifiers. The common gate amplifier arrangement may be used to stabilize voltage values in signal detection cell 641 and its associated sensing element (such as, e.g., sensing element 511 of FIG. 5). In some embodiments, transistors M₁₁, M₁₂, or M₁₃ may be omitted.

Transistor M₁₁ may be arranged at analog input A_{I}. Transistor M₁₁ may be, e.g., a MOSFET configured as a common gate amplifier with a reference voltage V_{ref2}. Transistor M₁₁ may stabilize the voltage at an anode of a sensing element to which it is connected. As a result, bias voltage across the sensing element may be stabilized. The speed and parasitic capacitance variations that would have resulted from bias voltage fluctuations during normal operation may be minimized by the introduction of transistor M₁₁. Transistor M₁₁ may additionally minimize the presence of residue charges in the sensing element during operation. Finally, the common gate amplifier formed by transistor M₁₁ may further perform the function of a charge extractor. Unwanted electrical effects, such as parasitic capacitance, may cause fluctuations in a charge extraction flow during an electron detection process. Transistor M₁₁ may have low input impedance. This may help to better extract the charge from the sensing element 511 and reduce the impact of parasitic capacitance in the sensing element on the detection results.

Similar to transistor M₁₁, transistor M₁₂ may be, e.g., a MOSFET configured as a common gate amplifier with a reference voltage V_{ref3}. Transistor M₁₂ may stabilize fluctuations at a cathode side of solid state current controlling device SSCCD located between transistors M₁₁ and M₁₂. As further discussed below, solid state current controlling device SSCCD may be, e.g., a silicon controlled rectifier, a thyristor or another solid state current controlling device. Transistor M₁₃ may form a third common gate amplifier with a reference voltage V_{ref4} configured to stabilize voltage values at capacitor C₁₁.

Signal detection cell 641 may further comprise an enable circuit and a bypass circuit configured to convert signal detection cell 641 from an initial state into, e.g., an enabled or bypass state based on enabling or bypass signals. In the initial state, for example, switch K₁₁ may be set to the higher position seen in FIG. 6, switch K₁₂ may be set to the lower position and switch K₁₄ may be set to an open state. In addition, a control unit (such as 590 of FIG. 5) may have previously output a signal to reset input R so that switch K₁₄ was set to a closed state to drain charge from storage capacitor C₁₁ prior to placing switch K₁₄ in the open state. The control unit may output a further signal to sample control signal input SP so that switch K₁₅ may be set to an open state.

In the enabled state, signal detection cell 641 may be activated for detection. In the enabled state, signal detection cell 641 will be ready to pass charge from its associated sensing element (such as sensing element 511 in FIG. 5) to storage capacitor C₁₁, such as by allowing solid state current controlling device SSCCD to be turned on when it receives a signal above a threshold. The enable circuit may comprise: enable signal input EN_{I}; enable signal output EN_{O}; and switches K₁₁ and K₁₂. The bypass circuit may comprise bypass signal input BP and switches K₁₁ and K₁₂. In some embodiments, the bypass circuit may be omitted.

The enable circuit may be configured to place signal detection cell 641 into the enabled state from the initial state. In the initial state configuration of switch K₁₁, an enabling signal may be transmitted from enable signal input EN_{I} to an upper input of AND gate G₁₁. The enabling signal may be, e.g., a high level voltage, or a value of “1” in digital terms. For example, if signal detection cell 641 is the first signal detection cell in an array (such as array 540 of FIG. 5), the enabling signal may be a signal value 1 from a logic gate (such as logic gate XOR or FIG. 5). Alternatively, the enabling signal may come from an enable signal output EN_{O} of a prior signal detection cell in an array of signal detection cells (such as array 540 of FIG. 5). In the initial state, inverse output Q̅ of flip-flop circuit F₁₁ (discussed below) may be configured to output a further signal value 1 to the lower input of AND gate G₁₁, such that AND gate G₁₁ receives a signal value of 1 from both its upper and lower inputs. AND gate G₁₁ may then output a signal to close a further switch K₁₃, activating a current detection circuit to place the signal detection cell 641 into the enabled state. For example, the closing of switch K₁₃may short control gate CG to the anode of solid state current controlling device SSCCD, changing the way it responds to signals it receives at its anode. This allows solid state current controlling device SSCCD to be triggered on when a signal (such as a voltage value) from its associated sensing element exceeds a predetermined threshold. When solid state current controlling device SSCCD is triggered, it may act as a switch to rapidly conduct charge from the anode to the cathode.

Alternatively, the bypass circuit of signal detection cell 641 may receive a bypass signal at bypass signal input BP. For example, the bypass signal may be generated from a control unit (such as control unit 590 in FIG. 5). The bypass signal may cause switches K₁₁ and K₁₂ to reverse their positions from what is shown in FIG. 6, such that switch K₁₁ is in the lower position and switch K₁₂ is in the higher position. In this case, an enabling signal will not pass to AND gate G₁₁ from enable signal input EN_{I}. Instead, the enabling signal will pass through switch K₁₂ to enable signal output EN_{O} and exit the signal detection cell 641. Further, the upper input of AND gate G₁₁ may be connected to ground by the new position of switch K₁₁ such that the upper input receives, e.g., a signal value of 0. Thus, switch K₁₃ may be prevented from closing and the current detection circuit may not be enabled.

Signal detection cell 641 may further comprise a current detection circuit configured to receive current, determine that a charged particle event such as an electron arrival event has occurred based on the received current, and store charge corresponding to the current. The current detection circuit may comprise: solid state current controlling device SSCCD; analog switch K₁₃; transistor M₁₂; storage capacitor C₁₁; voltage comparator A₁₁; resistor R₁₁; buffer amplifier A₁₃; voltage comparator A₁₂; flip-flop F₁₁; and AND gate G₁₁.

Solid state current controlling device SSCCD may act as the electron incoming event detector in each signal detection cell. Solid state current controlling device SSCCD may be, e.g., a silicon controlled rectifier, a thyristor or another solid state element configured to conduct current in one direction. For example, solid state current controlling device SSCCD may comprise four layers of alternating p-type and n-type material. Solid state current controlling device SSCCD may comprise, e.g., a combination of one pnp bipolar transistor and one npn bipolar transistor.

Solid state current controlling device SSCCD may include control gate CG configured to turn the solid state controlling device on and off in response to an electron arrival event. For example, when charge is generated at the electrodes of a sensing element due to, e.g., an electron arrival event, the charge may generate a signal that produces a voltage value at control gate CG. If the voltage value at control gate CG meets or exceeds a trigger threshold, control gate CG may trigger the solid state current controlling device to be in an “on” state in which current may pass through it. Solid state current controlling device SSCCD may remain in this on state until most of the charge from the sensing element has been extracted out and passed to storage capacitor C₁₁, which may be configured to store the charge passed by solid state current controlling device SSCCD. When the current falls below a holding current value, the solid state current controlling device SSCCD may be configured to switch from an on state to an off state, and further conduction may be prevented. Thus, solid state current controlling device SSCCD may be configured to self-deactivate after a current pulse drops below the holding current. The trigger threshold voltage, as well as the holding current threshold, may be programmable.

Solid state current controlling device SSCCD may be configured to extract charge rapidly and efficiently from an associated sensing element via analog input A_{I} when an electron arrival occurs at the sensing element. For instance, solid state current controlling device SSCCD may be configured as a thyristor. When triggered to the on state, a thyristor may advantageously exhibit a negative resistance, such that current may be increased at low voltages. This may result in rapid extraction of charge from the sensing element so that speed of the detection process may be improved.

As stated above, solid state current controlling device SSCCD can be a thyristor The on/off function of a thyristor may represent a great improvement over prior configurations, such as threshold detector 420 and related control circuitry of FIG. 4. The control gate of a thyristor may advantageously require a short response time, e.g., on the order of nanoseconds, to trigger the thyristor to an on state and begin receiving current. In this way the charge extraction process may be initiated quickly after an electron arrival event occurs. Similarly, the thyristor may shut itself down automatically when a holding current threshold is met. The thyristor may therefore be configured to operate in a rapid manner with low power consumption and a simplified control architecture. In addition to thyristors or silicon controlled rectifiers, other solid state current controlling devices may be configured to achieve these advantages.

When signal detection cell 641 is enabled by closing switch K₁₃, and an electron arrival event triggers control gate CG of solid state current controlling device SSCCD to turn on, charge may be passed to storage capacitor C₁₁ and stored. A signal at storage capacitor C₁₁ may be output to voltage comparator A₁₂ via an amplifier or buffer A₁₃. In some embodiments, storage capacitor C₁₁ may form a part of the amplifier or buffer A₁₃. In some embodiments, storage capacitor C₁₁ may be a separate component. If the signal at storage capacitor C₁₁ is high enough to indicate that an electron arrival event has been detected, voltage comparator A₁₂ may output a high level voltage (or 1 as digital data) to data input D of flip-flop F₁₁. Flip-flop F₁₁ may be, e.g., a data or D-type flip-flop circuit, and may be configured to pass data at data input D based on a signal from clock input CLK. In some embodiments, flip-flop F₁₁ may be another type of flip-flop, latch or other logic circuit.

Voltage comparator A₁₁ and resistor R₁₁ may be located at an opposite side of capacitor C₁₁ from solid state current controlling device SSCCD. Voltage comparator A₁₁ and resistor R₁₁ may output a negative pulse during each electron arrival event to clock input CLK of flip-flop F₁₁. The rising positive edge of the negative pulse may be used to as an edge-trigger to pass data from voltage comparator A₁₂ at data input D to output Q and inverse output Q̅ of flip-flop F₁₁. For instance, a first signal from output Q may be a high level voltage or signal value 1, and a second signal from inverse output Q̅ may be a low level voltage or signal value 0.

The signal value 0 from inverse output Q̅ may be output to the lower input of AND gate G₁₁, causing switch K₁₃ to be actuated from close to open. This may disable signal detection cell 641 so that solid state current controlling device SSCCD may no longer be triggered to pass current.

At the same time, the signal value 1 from output Q may be passed to operation status output OP. The signal value 1 from output Q may also be passed, via switch K₁₂, to enable signal output EN_{O}. The operation status output OP may output the signal value 1 as an operation status signal to a control unit, such as control unit 590 of FIG. 5. This may indicate to the control unit that an electron arrival event is detected at signal detection cell 641. The control unit may assign a time stamp to the indicated electron arrival event based on the signal from operation status output OP. Enable signal output EN_{O} may output the signal value 1 as an enabling signal to a further enable signal input EN_{I} at the next signal detection cell in the array. The next signal detection cell may then become enabled in the same manner discussed previously with respect to signal detection cell 641.

Alternatively, the next signal detection cell in the array may be bypassed, in which case the enabling signal may pass through the next signal detection cell by the bypass circuit. This process may repeat until the enabling signal reaches a signal detection cell that is in an initial state and ready to be enabled. In this way, signal detection cells may be automatically selected and enabled in rapid succession during a detection process. The sensing element-level architecture according to embodiments of the present disclosure may perform signal detection cell selection and switching with a fast, simplified, robust design. In addition, signal detection cells that are not needed may be disabled to reduce power consumption in the system. For example, in a bypassed detection cell, components that are not related to the enable circuit, bypass circuit, or (if present) transistor M₁₁, may be powered off.

Signal detection cell 641 may further comprise a signal processing output circuit configured to output a signal corresponding to an electron arrival event. The signal processing output circuit may comprise: operation status output OP; sample control signal input SP; analog switch K₁₅; and analog signal output A_{O}.

When operation status output OP transmits a signal to, e.g., a control unit as discussed above, the control unit may determine that signal detection cell 641 is storing charge from an electron arrival event, e.g. at storage capacitor C₁₁. The control unit may then interrogate the signal detection cell, immediately or at a later time, to read out the stored signal. The control unit may also generate a time stamp based on the operation status output OP signal to count the electron arrival event.

To read out the stored signal, a control signal may be sent to sample control signal input SP to actuate switch K₁₅ from the initial open state to a closed state. Internal amplifier or buffer A₁₃ may serve to minimize any disturbances resulting from the state change of switch K₁₅, as well as from the loading effect of voltage comparator A₁₂. In addition, amplifier or buffer A₁₃ may help improve a signal to noise ratio (SNR) of the signal detection cell. With switch K₁₅ closed, the signal stored at storage capacitor C₁₁ may be transmitted via amplifier or buffer A₁₃ to analog signal output A_{O} and to signal processing circuitry. For example, the stored signal may be sent to a voltage comparator, a group of voltage comparators, or a data convertor, such as converter 550 in FIG. 5. The signal processing circuitry may determine, e.g., energy level and overflow information about the electron arrival event as discussed with respect to FIG. 4. Overflow information may comprise, e.g., the first type or the second type, or other classes of overflow information, such as those disclosed in U.S. Publication No. 2019/0379682.

For example, a type 1 overflow may be determined based on information from analog output A_{O}. Type 2 overflow information may be determined, e.g., from the operational states of signal detection cells in the array. For example, there may be a situation in which all non-bypassed signal detection cells are in a state other than the enabled state within a predetermined time period. The other state may be, e.g., a storage state in which an electron arrival event has been detected, and the signal detection cell has not yet been read out or reset. This may indicate a loss of electron detection due to type 2 overflow during the predetermined time period. The predetermined time period may be based on, e.g., an average frequency of electron arrival events, as determined by the timing of recent arrival events or by the electron beam current.

In some embodiments, signal processing in a sensing element level circuit may be started when at least two electron arrival events have been captured and stored by at least two signal detection cells of the sensing element level circuit. For instance, in some embodiments, the automatic successive activation of each next signal detection cell may be achieved by maintaining an enabling signal from the previous signal detection cell until the next signal detection cell has detected an electron arrival event. This may be done by refraining from sending a reset signal to the previous signal detection cell until the next signal detection cell has detected the electron arrival event. During a regular operation mode, signal processing at the sensing element level circuit may be stopped, e.g., when only one signal detection cell remains that is presently storing information of an electron arrival event. Alternatively, if the sensing element is switched from a regular operation mode to an off mode, signal processing may proceed through all signal detection cells that are storing information of an electron arrival event.

Signal detection cell 641 may further comprise a reset circuit configured to reset the signal detection cell to an initial state. The reset circuit may comprise: reset input R; analog switch K₁₄; and flip flop F₁₁. A signal detection circuit may be reset to the initial state, e.g., after a detection signal has been read out or counted, or when a disabled or bypassed signal detection cell is brought back into operation. Alternatively, a reset signal may be sent simply to ensure that a signal detection cell is ready to be enabled. In some embodiments, a reset signal may be sent by a control unit when the signal detection cell is downstream from the presently enabled signal detection cell by a predetermined number of signal detection cells. For example, when a downstream signal detection cell is, e.g., five non-bypassed signal detection cells away from the presently enabled signal detection cell, the control unit may send a reset signal to ensure that the signal detection is ready to be enabled.

Reset input R may receive a reset signal to actuate switch K₁₄. This may provide a path to clear the charge from storage capacitor C₁₁. At the same time, the reset signal may be passed to clear input CLR of flip-flop F₁₁ to reset flip-flop F₁₁ to an initial state. For example, the reset signal to clear input CLR may ensure that outputs Q and Q̅ are valued at 0 and 1, respectively. The 0 output at Q may terminate a 1 signal at enable signal output EN_{O}. This may cease transmission of an enabling signal to an enable signal input EN_{I} of the next signal detection cell. At the same time, the 1 output at Q̅ may prepare signal detection cell 641 to become enabled again when it receives an enabling signal at its own enable signal input EN₁. In some embodiments, other signals may be sent to signal detection cell 641, and other operations may be performed, to reset signal detection cell to the initial state. For example, a signal may be sent to sample control output SP if switch K₁₅ needs to be set to an open state. Additionally, a bypass signal may be sent to bypass input BP if switches K₁₁ and K₁₂ must be reversed from their present state. After reset is completed, signal detection cell is again in the initial state and ready to receive an enabling signal at enable signal input EN₁.

The above circuits and components are provided by way of example, to illustrate one possible implementation of signal detection cells within a signal detection circuit, such as circuit 500 of FIG. 5. In some embodiments, the same or similar functions may be achieved by other combinations of switches, logic components, amplifiers and other circuit elements. For example, in some embodiments AND gate G₁₁ may comprise another logic gate, such as OR, XOR, NOT, NAND, NOR, XNOR, etc. In such embodiments, other circuitry may be configured to provide the appropriate inputs to logic gate G₁₁ so that it operates on switch K₁₃, or a component corresponding to switch K₁₃, in the desired manner. In general, a number of different configurations may be employed to perform the functions of, e.g., the enabling, bypass, current detection, readout, and reset circuits in some embodiments of the present disclosure.

Embodiments according to FIG. 5 and FIG. 6 may beneficially provide energy level and overflow information of electron detection events. However, in some embodiments such information may not be needed. In such cases, a pure electron counting architecture may be provided that is even further simplified and streamlined.

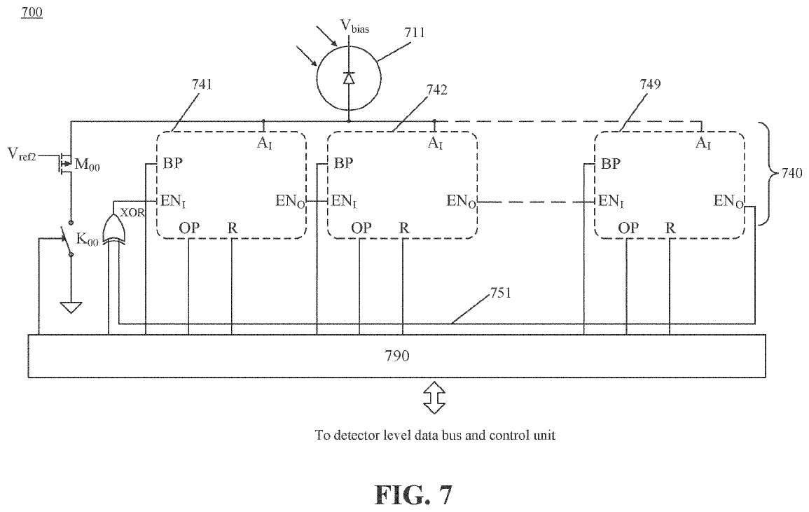

FIG. 7 illustrates a simplified block diagram of a sensing element level readout circuit design 700 with its corresponding sensing element 711, consistent with embodiments of the present disclosure. Sensing element 711 may correspond to, e.g., any of sensing elements 311-314 of FIGS. 3A-C or sensing element 511 of FIG. 5. Sensing element 711 may be a charged particle sensing element configured to generate an electrical signal in response to a charged particle arrival event. The electrical signal may be, e.g., an electrical charge, current or voltage. In some embodiments, sensing element 711 may be a photon sensing element.

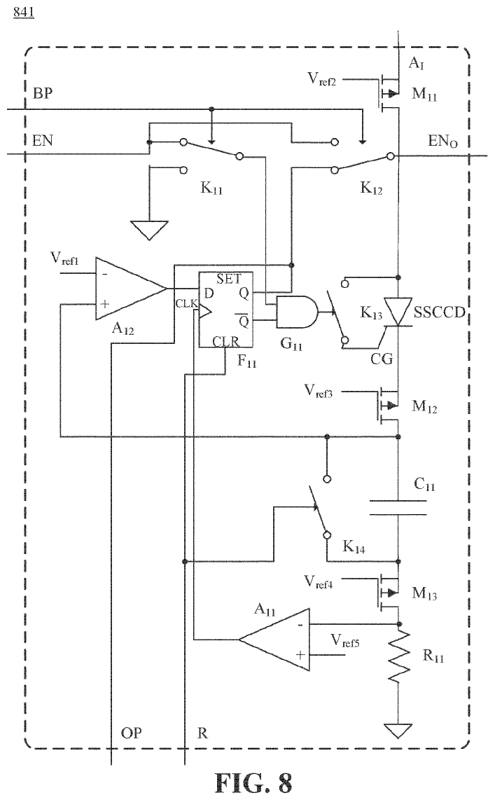

Circuit 700 may comprise an array 740 of signal detection cells, such as signal detection cells 741, 742, etc., up to 749. In some embodiments, circuit 700 may have a similar configuration to circuit 500 of FIG. 5, with the exception of the differences discussed below. Similar elements may be labeled with a leading 7 instead of a leading 5. In some embodiments, the differences in FIG. 7 may represent a structural difference, and in some embodiments, they may represent an operational difference. For example, a component that is present in FIG. 5 may be omitted from FIG. 7. In some embodiments, this omission may represent a structural difference and signify that the component may not be present in circuit 700. In some embodiments, this omission may represent an operational difference and signify that the component may be present but unused in sensing element level readout circuit design 700. For example, the component may be powered down or electrically decoupled from the illustrated elements of circuit 700 due to it being unnecessary for the presently disclosed operation. The same relationship may be applied below to signal detection cell 841 of FIG. 8 as it relates to signal detection cell 641 of FIG. 6.

In the case that no detailed information, such as energy level information, is needed about each electron arrival event, sensing element circuits 741-749 may be operated in a much simpler way that requires a less active role from control unit 790. The starting procedure may be the same as discussed above with respect to FIG. 5. A signal detection cell, such as 741, may be enabled by an enabling signal from, e.g., logic gate XOR. Alternatively, signal detection cell 741 may be bypassed, in which case the enabling signal may be passed to a further signal detection cell. Triggering and detection of an electron arrival event may likewise proceed in a similar manner to the embodiment of FIG. 5. However, signal detection cells in array 740 may not be configured with analog signal outputs Ao or sample control signal inputs SP. Instead, signal detection may be registered at control unit 790 simply based on signals from operation status outputs OP of each cell in the array 740. This operation mode may be similar to, e.g. a ring oscillator formed by one or multiple segments of delay lines. Signals may be, e.g., timestamped at sensing element level circuit 700 and used for simple and robust electron counting.

In some embodiments, the process of acquiring the counting results may be further simplified. For instance, instead of counting the signal detection at every signal detection cell, sensing element level circuit 700 may count cycles of array 740. For example, by counting, e.g., the number of first operation status output signals of first signal detection cell 741 (assuming it is not bypassed or otherwise disabled), or the number of last operation status output signals of last signal detection cell 749 (assuming it is not bypassed or otherwise disabled), or both, the sensing element level circuit 700 may determine how many times the entire array of signal detection cells has been cycled through. Alternatively, sensing element level circuit may be configured to receive a separate cycle output signal from, e.g., logic gate XOR or final enable signal output EN_{O} of final signal detection cell 749. Logic gate XOR or final enable signal output EN_{O} of final signal detection cell 749 may comprise a further output (not shown) coupled to control unit 790 for this purpose. In this way, the control unit may count a number of cycles of array 740 without receiving any operating status signals from operating status outputs OP until a residue count (below) is needed. When a number of cycles of array 740 is known, an electron count may be achieved. For example, a control unit may multiply the number of whole detection cycles by the number of non-bypassed signal detection cells in array 740, and add in a residue (e.g., the number of leftover detections remaining in a final partial cycle of array 740). To obtain the residue, the operation states of all non-bypassed cells may be acquired by control unit 790. Using this counting system, only the final residue cycle requires counting of every signal detection cell. Furthermore, the cycle length may be modified as desired by bypassing a specific number of signal detection cells. This may be done to tailor the cycle length to operational conditions such as the beam current. For example,. when beam current is high, the frequency of electron arrival events at a sensing element may be high, which may result in a high frequency of whole detection cycles. Because a reset operation of signal detection cells requires a certain amount of time, it may be necessary to reduce the cycle frequency to avoid, e.g., type 2 overflow. To reduce the cycle frequency, more signal detection cells may be brought into operation to increase the cycle length. However, when the frequency of electron arrival events is low (due to, e.g., low beam current), there may not be a need for so many signal detection cells. In this case, the cycle length may be shortened by bypassing some signal detection cells to reduce power consumption or increase the signal detection cell lifetime.

FIG. 8 illustrates a simplified diagram of an example of internal circuitry of a signal detection cell 841, consistent with some embodiments of the present disclosure. Signal detection cell 841 may be, e.g., one possible implementation of signal detection cells 741-749 of FIG. 7.

Signal detection cell 841 may be similar to, e.g., signal detection cell 641 of FIG. 6. However, because signal detection cell 841 may be designed for electron counting without a need to detect energy level, etc., signal detection cell 841 may be made simpler. For example, signal detection cell 841 may omit the sample control signal input SP, analog signal output A_{O}, and amplifier or buffer A₁₃ of FIG. 6. As discussed above with respect to FIG. 7, electron counting may be achieved simply by, e.g., outputting a signal from operation status output OP. The signal from operation status output OP may generated, e.g., from output Q of flip flop F₁₁ based on an input from comparator A₁₂. However, once this output from comparator A₁₂ has been sent to flip flop F₁₁, there may be no more need for capacitor C₁₁ to store the charge it has received from solid state current controlling device SSCCD.

Because capacitor C₁₁ is not required to hold charge for a later readout, a reset operation at reset input R may be executed after the next signal detection cell has registered an electron arrival event. Signal detection cell 841 may provide a simple and fast system for electron counting. Signal detection cell 841 may offer reduced power consumption and manufacturing costs over other designs..

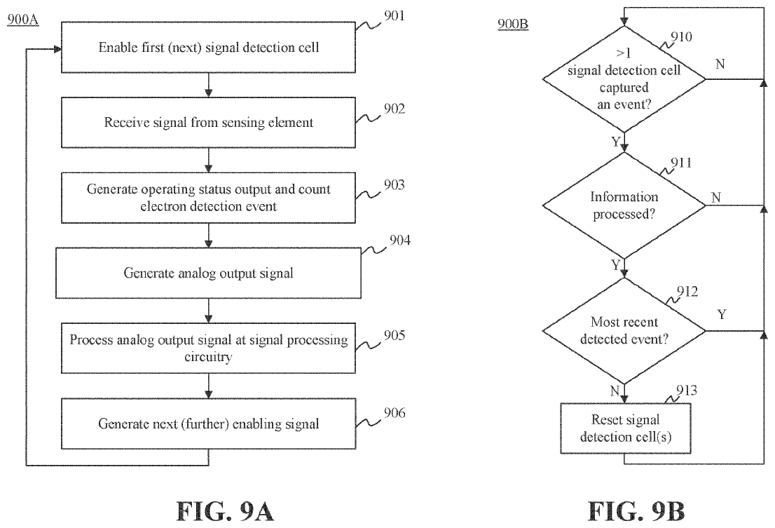

FIG. 9A is a flowchart illustrating a method 900A for charged particle detection, consistent with embodiments of the disclosure. Method 900A may be performed by, e.g., a sensing element level circuit in a detector of a charged-particle beam system (such as sensing element level circuit 500 of FIG. 5). The sensing element level circuit may include circuitry (e.g., a memory and a processor) programmed to implement method 900. A signal detection cell, such as signal detection cell 641 of FIG. 6, may be operated in accordance with method 900. Processing consistent with method 900 may be performed on a sensing element by sensing element basis.

At step 901, a first signal detection cell may receive an enabling signal to activate the signal detection cell from an initial state. The first signal detection cell may be a first non-bypassed signal detection cell in an array of signal detection cells. The first signal detection cell may receive the enabling signal from, e.g., a logic gate based on an initiating signal from a control unit. Upon enablement by the enabling signal, a solid state current controlling device inside the first signal detection cell may be configured to receive a signal from a sensing element. For example, the enabling signal may cause a switch to be closed that allows a control gate of the solid state current controlling device to receive current. The solid state current controlling device may be, e.g., a silicon controlled rectifier or other thyristor. Alternatively, the first signal detection cell of method 900A may receive an enabling signal from the enable signal output of a previous signal detection cell.

At step 902, the signal detection cell receives a signal from a sensing element. The sensing element may be coupled to an analog signal input of the detection cell via, e.g., an input bus. The signal detection cell may be coupled to an analog signal input of every signal detection cell of the array by the input bus. The signal may be generated at the sensing element by an arrival event, such as an electron arrival event, and passed to the solid state current controlling device. If the signal exceeds a trigger threshold at a control gate of the solid state current controlling device, the solid state current controlling device may be turned on and begin to extract current from the sensing element. The solid state current controlling device may remain on and continue to extract current while the current remains at or above a holding current. The extracted current may be passed to a storage capacitor and stored. When the current falls below the holding current, the solid state current controlling device may be turned off and extraction may be halted.

At step 903, the signal detection cell may generate an operating status output signal. The operating status output signal may indicate to the control unit that an electron arrival event has occurred. For example, the control unit may generate a time stamp used for counting electron arrival events based on the operating status output signal. The operating status output signal may be generated when, e.g., a flip flop circuit passes a data input signal from a voltage comparator at one terminal of the storage capacitor based on a clock input signal from a further voltage comparator at the other terminal of the storage capacitor. The data may be passed to an output of the flip flop. The output of the flip flop may generate the operating status output signal. The output of the flip flop may also generate a new enabling signal to an enabling signal output discussed at step 906.

At step 904, the signal detection cell may generate an analog output signal. For example, after the control unit determines that an electron arrival event has occurred based on the operating status output signal, the control unit my send a sample control signal via a sample control signal input to a switch. The switch may close a path between charge stored at the signal storage circuit and an analog output of the signal detection cell to generate the analog output signal. The analog output signal may be passed to, e.g., signal processing circuitry via an analog signal bus.

At step 905, the analog output signal may be processed by the signal processing circuitry. For example, the signal processing circuitry may comprise a voltage comparator, a group of voltage comparators, or a data convertor such as an analog-to-digital converter (ADC). The signal processing circuitry may process the analog output signal to determine information about the associated detection event, such as energy level or overflow information.

At step 906, the first signal detection cell may generate a next enabling signal to activate a next signal detection cell in the array. For example, as discussed above at step 903, the enabling signal may be generated concurrently with the generation of the operating status output signal. The enabling signal may proceed from an enabling signal output of the first signal detection cell to an enabling signal input of the next signal detection cell. At this point, the process may return to step 901 and repeat for the next signal detection cell.

If, on the other hand, the next signal detection cell is in a bypass state, the enabling signal may be passed directly through the next signal detection cell along a bypass circuit to its own enabling signal output. The enabling signal may then be passed to a further enabling signal input of a further signal detection cell. This may continue until the enabling signal reaches a non-bypassed signal detection cell, at which point the non-bypassed signal detection cell may be enabled.

A second loop of method 900A is illustrated by the language in parentheses at steps 901 and 906. At a second iteration of step 901, the next signal detection cell may receive an enabling signal sent by the first signal detection cell in the first iteration of step 906. After the next signal detection cell receives and process an electron arrival event at a second iteration of steps 902-905, the next signal detection cell may generate a further enabling signal at a second iteration of step 906 to activate a further signal detection cell in the array.

FIG. 9B is a flowchart illustrating a method 900B for charged particle detection, consistent with embodiments of the disclosure. Method 900B comprises a resetting method and may be performed in conjunction with, e.g., method 900A of FIG. 9A. For example, method 900B may begin after a detection operation is enabled at step 901 of method 900A, and may continue for the duration of a detection operation. Method 900B may be performed by, e.g., a sensing element level circuit in a detector of a charged-particle beam system (such as sensing element level circuit 500 of FIG. 5). The sensing element level circuit may include circuitry (e.g., a memory and a processor) programmed to implement method 900. A signal detection cell, such as signal detection cell 641 of FIG. 6, may be operated in accordance with method 900. Processing consistent with method 900B may be performed on a sensing element by sensing element basis.

At step 910 a control unit (e.g., a control unit of a sensing element level circuit, a higher level control unit of a charged particle detector, or another control unit of a charged particle beam apparatus) may determine whether more than one signal detection cell has received and processed an electron arrival event. For example, the control unit may make this determination based on an operating status output from the signal detection cells generated in step 903 of method 900A. In some embodiments, method 900B may not proceed until this two-cell condition is satisfied, as illustrated by the no output “N” leading back to an input of step 910. When the condition is satisfied, the method may proceed to step 911.

At step 911, the control unit may determine whether information (such as information from the analog signal outputs) from the more than one signal detection cells has been processed. For any signal detection cells having information that has already been processed, the method may proceed to step 912. Otherwise, the method may revert to step 910 and the process loop may begin again.

At step 912, the control unit may determine whether any signal detection cells that passed step 911 are storing the most recently captured electron arrival event. For the signal detection cell storing the most recently captured electron arrival event, the process also reverts to step 910. In this way, the signal detection cell storing the most recently captured electron arrival event may continue to enable the presently enabled signal detection cell.

However, the remaining signal detection cells may be reset to an initial state at step 913, e.g., by transmitting a reset signal to a reset input of the signal detection cell. The reset signal may clear any charge at the storage capacitor, such as by closing a switch to drain any stored charge. The reset signal may also revert internal logic circuitry to the initial state. For example, the reset signal may be transmitted to a clear input of a flip flop circuit to prepare the flip flop for another enabling signal. Once placed in the initial state, the signal detections cell may be ready for another enabling signal to repeat the process of method 900B as well as, e.g., method 900A.

The methods 900A and 900B may provide fast, simplified, robust methods of signal detection that reduce the need for active control circuitry to keep the process moving, while retaining all the functionality of comparative systems such as those disclosed with respect to FIG. 4. However, if complex detection information such as energy level and overflow are not needed, a method may be employed that uses a simpler architecture.

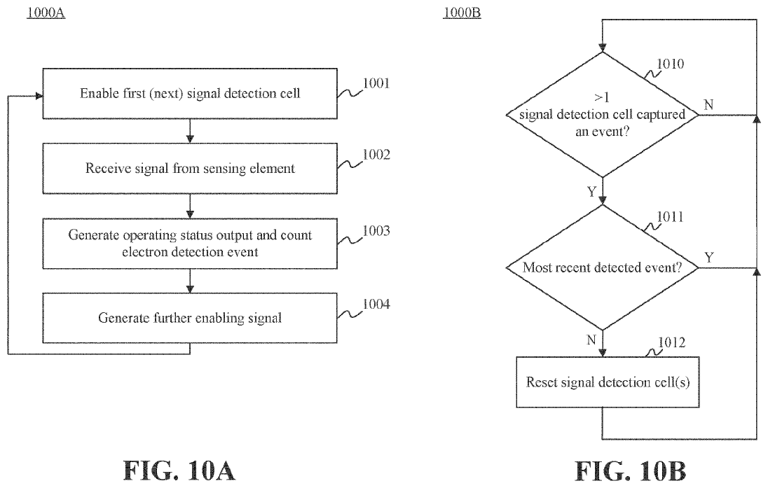

FIG. 10A is a flowchart illustrating a method 1000A for charged particle detection, consistent with embodiments of the disclosure. Method 1000A may be performed by, e.g., a sensing element level circuit in a detector of a charged-particle beam system (such as sensing element level circuit 500 of FIG. 5 or sensing element level circuit 700 of FIG. 7). The sensing element level circuit may include circuitry (e.g., a memory and a processor) programmed to implement method 1000A. A signal detection cell, such as signal detection cell 641 of FIG. 6 or signal detection cell 841 of FIG. 8, may be operated in accordance with method 1000A. Processing consistent with method 1000A may be performed on a sensing element by sensing element basis. Steps 1001,1002, and 1004 of FIG. 10A may proceed in a similar manner to steps 901, 902, and 906 of FIG. 9A respectively. Therefore, a detailed description is omitted here.

Step 1003 as well may proceed in a manner similar to the counting and timestamping referenced at step 903. For example, when an operating status output signal is sent to a control unit, the control unit may generate a timestamp representing an electron arrival event. The control unit may use timestamps or other digital information based on operating status output signals to maintain a count of events, such as electron arrival events, during a detection process.

In this way, when an energy level discrimination function is not needed, electron counting may be performed in the simplified method 1000A of FIG. 10A. The method 1000A may also be performed on a simplified circuit. For example, the steps 1001-1004 of method 1000A may be performed in sensing element level circuit 700 of FIG. 7 using, e.g., a signal detection cell design shown in FIG. 8, in which components for, e.g., reading out energy level information are not used.

FIG. 10B is a flowchart illustrating a method 1000B for charged particle detection, consistent with embodiments of the disclosure. Method 1000B comprises a resetting method and may be performed in conjunction with, e.g., method 1000A of FIG. 10A. Method 1000B may be, e.g., a simplified version of method 900B. For example, steps 1010-1012 of FIG. 10B may proceed in a similar manner to steps 910, 912, and 913 of FIG. 9B respectively. Therefore, a detailed description is omitted here. However, method 1000B may omit a step of determining whether information from a signal detection cell has been processed (such as in step 911 of FIG. 9B), because energy level information may not be determined in the simplified methods of FIGS. 10A-B. Therefore, step 1011 may proceed directly to a reset step 1012 without making such a determination, and without waiting for information from an analog signal output to be processed before resetting a signal detection cell.

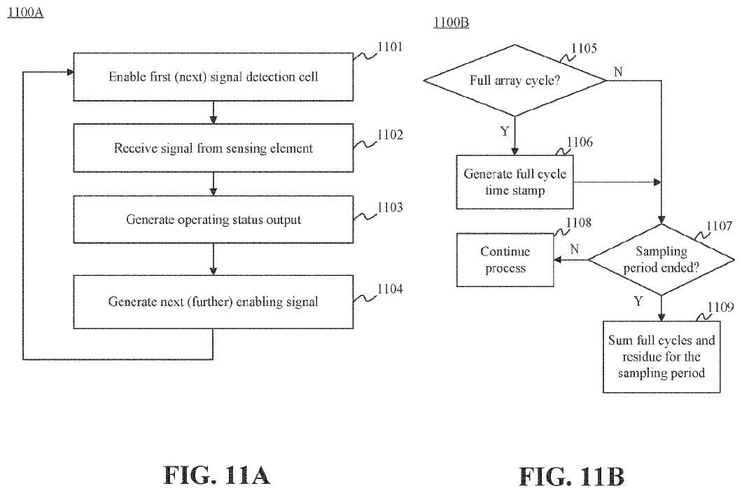

Furthermore, in some embodiments of the present disclosure, the amount of counting may be reduced by counting whole cycles of signal detection cells rather than counting every detection event of every signal detection cell. FIGS. 11A and 11B are flowcharts illustrating methods 1100A and 1100B for charged particle detection, consistent with embodiments of the disclosure. Methods 1100A and 1100B may be preferable, e.g., when an individual time stamp is not needed for each electron arrival event. Methods 1100A-B may be performed by, e.g., a sensing element level circuit in a detector of a charged-particle beam system (such as sensing element level circuit 500 of FIG. 5 or sensing element level circuit 700 of FIG. 7). The sensing element level circuit may include circuitry (e.g., a memory and a processor) programmed to implement methods 1100A-B. A signal detection cell, such as signal detection cell 641 of FIG. 6 or signal detection cell 841 of FIG. 8, may be operated in accordance with methods 1100A-B. Processing consistent with methods 1100A-B may be performed on a sensing element by sensing element basis. Steps 1101, 1102, and 1104 of FIG. 11A may proceed in a similar manner to steps 901, 902, and 906 of FIG. 9A or steps 1001, 1002, and 1004 of FIG. 10A. Therefore, a detailed description is omitted here. Further, a resetting operation may proceed according to, e.g., method 1000B of FIG. 10B.

At step 1103, a signal detection cell may generate an operating status output in a similar manner to step 903 of FIG. 9A or step 1003 of FIG. 10A. The generation of new enabling signals at step 1104 may proceed as discussed above. However, step 1103 may differ in that not every time stamp of every signal detection cell may be counted. Instead, the control unit may count the electron arrival events in multiples of a full detection cycle.

Method 1100B of FIG. 11B illustrates a cycle counting method that may be used, e.g., in conjunction with method 1100A. Method 1100B may count detection cycles during a sampling period set by, e.g., the control unit. At step 1105, the control unit may determine whether an operating status output (such as received at step 1103 of FIG. 11A) represents a full detection cycle of a signal detection cell array. For example, the control unit may determine whether the signal detection cell that generated the operating status output is a counting cell. A counting cell may be, e.g., a signal detection cell that is used to determine whether a full cycle of signal detection has occurred in an array of signal detection cells. For example, a first non-bypassed signal detection cell in the array, a last non-bypassed signal detection cell in the array, or both, may be utilized as a counting cell. In general, any signal detection cell may be utilized as a counting cell. Alternatively, method 1100 may comprise receiving a separate cycle output signal from, e.g., logic gate XOR or final enabling signal output EN_{O} of a final signal detection cell in the array. Further, a whole or partial cycle may be determined by other detection cells in the array. For example, if there is any signal detection cell other than the first or the last signal detection cell used as a counting cell, having a high value (or 1) at its operating status output OP, the cycle may be determined not to be a whole cycle. In this way, the control unit may count a number of cycles of an array without summing every operating status signal from operating status outputs OP unless a residue count is needed.

If the detection does represent a full cycle, then the method 1100B may proceed to step 1106 where one full detection cycle timestamp is generated at the control unit. If the detection does not represent a full cycle, the method may proceed to step 1107.

At step 1107, the control unit may determine whether a sampling period has ended. A sampling period may take place based on predetermined timing settings set by, e.g., the control unit. In some embodiments the sampling period may correspond to a normal operation period of a charged particle beam apparatus. In some embodiments, the sampling period may correspond to another timing interval. If the sampling period has not ended, then the process continues as illustrated at step 1108. If sampling period has ended, then the method may proceed to step 1109.

At step 1109, a residue may be counted and summed with the full detection cycles. The residue may comprise time stamps from operating status signals retained by the control unit from the last partial cycle of signal detection cells. For example, if a signal detection cell array comprises ten active cells, then each full cycle represents ten signal detection events. However, as discussed above, the sampling period may end part-way through a full detection cycle, e.g., when only five signal detection cells have registered an event. In this case, the control unit may count individual operating status output signals from the signal detection cells to yield an accurate count of detection events. The full cycles may be summed with the residue to determine a full count of detection events. In the ten-cell example above, for instance, the control unit may multiply the number of full cycle counts by the number of active cells within the array (ten). and then add the residue (five in the example above). The summation of full cycles with the residue may represent a total count of charged particle detection events during the sampling period. The method 1100B may be utilized to produce an accurate count of detection events while minimizing the actual counting performed by signal processing circuitry.

Data from all the sensing element level circuits within a charged particle detector may be summed in a sampling period-by-sampling period manner. In this way, a detection result similar or identical to the counting methods above may be generated.

Further, the method 1100B may be customized for a detection operation by choosing an optimal number of signal detection cells in the array. Unneeded signal detection cells may be powered down and bypassed using signal bypass circuitry.

Alternatively to counting method 1100B, a higher level control unit, such as a detector-level control unit, may acquire the full cycle timestamps of each sensing element level circuit, e.g., as they are generated. The detector may thus sum all of the full cycle counts from every sensing element in the detector. From this summation of cycle counts, a detection signal may be generated to produce a charged particle beam image. A non-transitory computer-readable medium may be provided that stores instructions for a processor of a controller (e.g., controller 590 in FIG. 5 or controller 790 in FIG. 7) for detecting charged particles according to, e.g., the exemplary flowcharts of FIGS. 9-11, consistent with embodiments of the present disclosure. For example, the instructions stored in the non-transitory computer-readable medium may be executed by the circuitry of the controller for performing method 900, method 1000, or method 1100 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

Embodiments of the present disclosure may further be described by the following clauses:
1. A method of detecting a charged particle event in a charged particle counting detector, comprising:
enabling, by the charged particle counting detector, a first solid state current controlling device (SSCCD) of a first signal detection cell to be put into an on state in which the first SSCCD can conduct current from a charged particle sensing element of the charged particle counting detector;
outputting, by the charged particle sensing element, a first current pulse from the charged particle sensing element in response to a first charged particle arriving at the charged particle sensing element, wherein the first current pulse triggers the first SSCCD to the on state;
in response to the first SSCCD being triggered to the on state, conducting the first current pulse from an input to an output of the first SSCCD; and
receiving a second enabling signal at a second signal detection cell comprising a second SSCCD, the second enabling signal being based on the first current pulse,
wherein the second enabling signal enables a second SSCCD of the second signal detection cell to be put into the on state in which the second SSCCD can conduct current from the charged particle sensing element.
2. The method of clause 1, wherein the first SSCCD or the second SSCCD comprises a thyristor.
3. The method of clause 1, wherein enabling the first SSCCD of the first signal detection cell comprises closing an enabling switch to couple a first control gate of the first SSCCD to an anode of the first SSCCD.
4. The method of clause 1, wherein enabling the first SSCCD of the first signal detection cell comprises receiving an initial enabling signal from a control unit of a sensing element level circuit of the charged particle counting detector.
5. The method of clause 1, further comprising:
in response to the first current pulse exceeding a threshold, beginning to conduct current by the first SSCCD.
6. The method of clause 1, further comprising:
in response to the first current pulse falling below a threshold, ceasing to conduct current by the first SSCCD.
7. The method of clause 6, wherein ceasing to conduct current by the first SSCCD comprises ceasing to conduct current by self-deactivation of the first SSCCD.
8. The method of clause 1, further comprising:
transmitting, by a current detection circuit of the first signal detection cell, the first current pulse from the output of the first SSCCD to a storage capacitor; and storing a signal corresponding to the first current pulse at the storage capacitor.
9. The method of clause 1, further comprising:
generating, by a signal processing output circuit of the first signal detection cell, an operating status output signal based on the first current pulse.
10. The method of clause 9, further comprising:
transmitting, by the signal processing output circuit, the operating status output signal to signal processing circuitry; and
detecting a charged particle arrival event at the signal processing circuitry based on the operating status output signal.
11. The method of clause 9, further comprising:
transmitting, by the signal processing output circuit, the operating status output signal to signal processing circuitry; and
counting a full cycle of charged particle arrival events at the signal processing circuitry based on the operating status output signal,
wherein the number of charged particle arrival events counted in the full cycle corresponds to a number of non-bypassed signal detection cells coupled to the output of the charged particle sensing element.
12. The method of clause 1, further comprising:
generating, by an enable circuit of the first signal detection cell, the second enabling signal based on the first current pulse.
13. The method of clause 1, further comprising:
generating, by a signal processing output circuit of the first signal detection cell, a detection result signal at an analog signal output of the first signal detection cell; and
transmitting the detection result signal to signal processing circuitry.
14. The method of clause 13, further comprising:
processing energy level information of the detection result signal at the signal processing circuitry.
15. The method of clause 13, further comprising:
processing overflow information of the detection result signal at the signal processing circuitry.
16. The method of clause 13, further comprising:
inputting, by a control unit of the sensing element level circuit, a sample control signal to a sample control signal input of the first signal detection cell to generate the detection result signal at the analog signal output.
17. The method of clause 1, further comprising:
resetting, by a reset circuit of the first signal detection cell, the first signal detection cell to an initial state,
wherein in the initial state, the first signal detection cell is configured to be enabled by a further enabling signal.
18. The method of clause 1, further comprising:
bypassing a third signal detection cell comprising a third SSCCD by a bypass circuit of the third signal detection cell,
wherein the bypass circuit is configured to cause signals to pass from an enabling signal input of the third signal detection cell to an enabling signal output of the third signal detection cell without enabling a third SSCCD of the third detection cell to be put into the on state in which the third SSCCD can conduct current from the charged particle sensing element.
19. The method of clause 1, wherein the charged particle sensing element comprises a PIN diode.
20. The method of clause 1, wherein the first charged particle arriving at the charged particle sensing element comprises an electron.
21. A charged particle counting detector, comprising:
a charged particle sensing element configured to output a first current pulse in response to a first charged particle arriving at the charged particle sensing element;
a first signal detection cell comprising a first solid state current controlling device (SSCCD) that is configured a) to be enabled, by a first enabling signal, to be put into an on state in which the first SSCCD can conduct current from the charged particle sensing element, b) to be triggered to the on state by the first current pulse, and c) to conduct the first current pulse to an output of the first SSCCD in response to the first SSCCD being triggered to the on state; and
a second signal detection cell configured to receive a second enabling signal and comprising a second SSCCD that is configured to be enabled, by the second enabling signal, to be put into an on state in which the second SSCCD can conduct current from the charged particle sensing element.
22. The charged particle counting detector of clause 21, wherein the first SSCCD or the second SSCCD comprises a thyristor.
23. The charged particle counting detector of clause 21, the first SSCCD of the first signal detection cell is configured to be enabled by closing an enabling switch to couple a first control gate of the first SSCCD to an anode of the first SSCCD.
24. The charged particle counting detector of clause 21, the first signal detection cell is configured to receive the first enabling signal from a control unit.
25. The charged particle counting detector of clause 21, wherein the first SSCCD is configured to begin conducting current in response to the first current pulse exceeding a threshold.
26. The charged particle counting detector of clause 21, wherein the first SSCCD is configured to cease conducting current in response to the first current pulse falling below a threshold.
27. The charged particle counting detector of clause 26, wherein ceasing to conduct current by the first SSCCD comprises ceasing to conduct current by self-deactivation of the first SSCCD.
28. The charged particle counting detector of clause 21, wherein:
the first SSCCD is configured to transmit the first current pulse to a storage capacitor; and the storage capacitor is configured to store a signal corresponding to the first current pulse.
29. The charged particle counting detector of clause 21, wherein the first signal detection cell is configured to generate an operating status output signal based on the first current pulse.
30. The charged particle counting detector of clause 29, further comprising signal processing circuitry;
wherein:
the first signal detection cell is configured to transmit the operating status output signal to the signal processing circuitry; and
the signal processing circuitry is configured to detect a charged particle arrival event based on the operating status output signal.
31. The charged particle counting detector of clause 29, further comprising signal processing circuitry,
wherein:
the first signal detection cell is configured to transmit the operating status output signal to the signal processing circuitry;
the signal processing circuitry is configured to count a full cycle of charged particle detection event based on the operating status output signal; and
the number of charged particle arrival events counted in the full cycle corresponds to a number of non-bypassed signal detection cells coupled to the output of the charged particle sensing element.
32. The charged particle counting detector of clause 21, wherein the first signal detection cell is configured to generate the second enabling signal based on the first current pulse.
33. The charged particle counting detector of clause 21, further comprising signal processing circuitry,
wherein the first signal detection cell is configured to:
generate a detection result signal at an analog signal output of the first signal detection cell; and transmit the detection result signal to the signal processing circuitry.
34. The charged particle counting detector of clause 33, wherein the signal processing circuitry is configured to process energy level information of the detection result signal.
35. The charged particle counting detector of clause 33, wherein the signal processing circuitry is configured to process overflow information of the detection result signal.
36. The charged particle counting detector of clause 33, wherein the first signal detection cell is configured to generate the detection result signal at the analog signal output in response to receiving a sample control signal at a sample control signal input of the first signal detection cell.
37. The charged particle counting detector of clause 21, wherein:
the first signal detection cell is configured to be reset to an initial state by a reset signal; and
in the initial state, the first signal detection cell is configured to be enabled by a further enabling signal.
38. The charged particle counting detector of clause 21, wherein:
the first signal detection cell comprises a bypass circuit; and
the bypass circuit is configured to cause signals to pass from an enabling signal input of the first signal detection cell to an enabling signal output of the first signal detection cell without enabling the first detection cell to be put into the on state in which the first SSCCD can conduct current from the charged particle sensing element.
39. The charged particle counting detector of clause 21, wherein the charged particle sensing element comprises a PIN diode.
40. The charged particle counting detector of clause 21, wherein the first charged particle arriving at the charged particle sensing element comprises an electron.
41. The charged particle counting detector of clause 21, wherein the second signal detection cell is configured to receive the second enabling signal from the first signal detection cell.
42. A charged particle counting detector, comprising:
a charged particle sensing element;
a first signal detection cell coupled to an output of the charged particle sensing element and configured to:
   receive a first charged particle arrival signal from the charged particle sensing element based on a first charged particle arrival event at the charged particle sensing element, and
   generate a detection output based on the first charged particle arrival signal, the detection output comprising information about the first charged particle arrival event; and
a second signal detection cell coupled to an output of the charged particle sensing element and configured to receive an enabling signal based on the first charged particle arrival signal, the enabling signal being configured to enable the second signal detection cell to receive a second charged particle arrival signal from the charged particle sensing element based on a second charged particle arrival event at the charged particle sensing element.
43. A signal detection cell for a charged particle counting detector, comprising:
an enable signal input configured to receive a first enabling signal to enable the signal detection cell to detect a charged particle arrival signal from a charged particle sensing element;
an analog signal input configured to receive the charged particle arrival signal from the charged particle sensing element;
an operation status output configured to output an operation status signal based on the charged particle arrival signal; and
an enable signal output configured to output a second enabling signal to be provided to a further signal detection cell based on the charged particle arrival signal.
44. The signal detection cell of clause 43, further comprising:
an analog signal output configured to output a detection signal based on the charged particle arrival signal.
45. The signal detection cell of clause 44, wherein the analog signal output comprises energy level information of the charged particle arrival signal.
46. The signal detection cell of clause 44, wherein the analog signal output comprises overflow information of the charged particle arrival signal.
47. The signal detection cell of clause 44, further comprising:
a sample control signal input configured to receive a sample control signal;
wherein the analog signal output is configured to output the detection signal in response to receiving the sample control signal.
48. The signal detection cell of clause 43, further comprising:
a bypass signal input configured to input a bypass signal;
wherein the bypass signal is configured to cause a path to be closed between the enable signal input and the enable signal output.
49. The signal detection cell of clause 43, further comprising:
a reset signal input configured to receive a reset signal;
wherein the reset signal is configured to cause the signal detection cell to be reset to an initial state,
wherein in the initial state the signal detection cell is configured to be enabled by a third enabling signal.
50. A non-transitory computer-readable medium that stores a set of instructions that is executable by at least one processor of an apparatus to cause the apparatus to perform a method comprising:
enabling a first solid state current controlling device (SSCCD) of a first signal detection cell to be put into the on state in which the first SSCCD can conduct current from a charged particle sensing element of a charged particle counting detector;
outputting a first current pulse from the charged particle sensing element in response to a first charged particle arriving at the charged particle sensing element, wherein the first current pulse triggers the first SSCCD to the on state;
in response to the first SSCCD being triggered to the on state, conducting the first current pulse from an input to an output of the first SSCCD; and
receiving a second enabling signal at a second signal detection cell comprising a second SSCCD, the second enabling signal being based on the first current pulse,
wherein the second enabling signal enables the second SSCCD of the second signal detection cell to be put into the on state in which the second SSCCD can conduct current from the charged particle sensing element.
51. The non-transitory computer-readable medium of clause 50, wherein the first SSCCD or the second SSCCD comprises a thyristor.
52. The non-transitory computer-readable medium of clause 50, wherein enabling the first SSCCD of the first signal detection cell comprises closing an enabling switch to couple a first control gate of the first SSCCD to an anode of the first SSCCD.
53. The non-transitory computer-readable medium of clause 50, wherein enabling the first control gate of the first SSCCD of the first signal detection cell comprises receiving an initial enabling signal from a control unit of the sensing element level circuit of the charged particle detector.
54. The non-transitory computer-readable medium of clause 50, wherein the set of instructions that is executable by the at least one processor of the apparatus causes the apparatus to further perform:
in response to the first current pulse exceeding a threshold, beginning to conduct current by the first SSCCD.
55. The non-transitory computer-readable medium of clause 50, wherein the set of instructions that is executable by the at least one processor of the apparatus causes the apparatus to further perform:
in response to the first current pulse falling below a threshold, ceasing to conduct current by the first SSCCD.
56. The non-transitory computer-readable medium of clause 55, wherein ceasing to conduct current by the first SSCCD comprises ceasing to conduct current by self-deactivation of the first SSCCD.
57. The non-transitory computer-readable medium of clause 50, wherein the set of instructions that is executable by the at least one processor of the apparatus causes the apparatus to further perform:
transmitting the first current pulse from the output of the first SSCCD to a storage capacitor: and
storing a signal corresponding to the first current pulse at the storage capacitor.
58. The non-transitory computer-readable medium of clause 50, wherein the set of instructions that is executable by the at least one processor of the apparatus causes the apparatus to further perform:
generating an operating status output signal based on the first current pulse.
59. The non-transitory computer-readable medium of clause 58, wherein the set of instructions that is executable by the at least one processor of the apparatus causes the apparatus to further perform:
transmitting the operating status output signal to signal processing circuitry; and
detecting a charged particle arrival event at the signal processing circuitry based on the operating status output signal.
60. The non-transitory computer-readable medium of clause 58, wherein the set of instructions that is executable by the at least one processor of the apparatus causes the apparatus to further perform:
transmitting the operating status output signal to signal processing circuitry; and
counting a full cycle of charged particle arrival events at the signal processing circuitry based on the operating status output signal,
wherein the number of charged particle arrival events counted in the full cycle corresponds to a number of non-bypassed signal detection cells coupled to the output of the charged particle sensing element.
61. The non-transitory computer-readable medium of clause 50, wherein the set of instructions that is executable by the at least one processor of the apparatus causes the apparatus to further perform:
generating the second enabling signal based on the first current pulse.
62. The non-transitory computer-readable medium of clause 50, wherein the set of instructions that is executable by the at least one processor of the apparatus causes the apparatus to further perform:
generating a detection result signal at an analog signal output of the first signal detection cell; and
transmitting the detection result signal to signal processing circuitry.
63. The non-transitory computer-readable medium of clause 62, wherein the set of instructions that is executable by the at least one processor of the apparatus causes the apparatus to further perform:
processing energy level information of the detection result signal at the signal processing circuitry.
64. The non-transitory computer-readable medium of clause 62, wherein the set of instructions that is executable by the at least one processor of the apparatus causes the apparatus to further perform:
processing overflow information of the detection result signal at the signal processing circuitry.
65. The non-transitory computer-readable medium of clause 62, wherein the set of instructions that is executable by the at least one processor of the apparatus causes the apparatus to further perform:
inputting a sample control signal to a sample control signal input of the first signal detection cell to generate the detection result signal at the analog signal output.
66. The non-transitory computer-readable medium of clause 50, wherein the set of instructions that is executable by the at least one processor of the apparatus causes the apparatus to further perform:
resetting the first signal detection cell to an initial state,
wherein in the initial state, the first control gate of the first signal detection cell is configured to be enabled by a further enabling signal.
67. The non-transitory computer-readable medium of clause 50, wherein the set of instructions that is executable by the at least one processor of the apparatus causes the apparatus to further perform:
bypassing a third signal detection cell comprising a third SSCCD by a bypass circuit of the third signal detection cell,
wherein the bypass circuit is configured to cause signals to pass from an enabling signal input of the third signal detection cell to an enabling signal output of the third signal detection cell without enabling a third SSCCD of the third detection cell to be put into the on state in which the third SSCCD can conduct current from the charged particle sensing element.
68. The non-transitory computer-readable medium of clause 50, wherein the charged particle sensing element comprises a PIN diode.
69. The non-transitory computer-readable medium of clause 50, wherein the first charged particle arriving at the charged particle sensing element comprises an electron.
70. The non-transitory computer-readable medium of clause 50, wherein the apparatus comprises a sensing element level circuit of a charged particle detector.
71. A non-transitory computer-readable medium that stores a set of instructions that is executable by at least one processor of an apparatus to cause the apparatus to perform a method comprising:
enabling a first solid state current controlling device (SSCCD) of a first signal detection cell of a charged particle detector to be put into an on state in which the first SSCCD can conduct current from a charged particle sensing element of the charged particle counting detector, wherein
the charged particle sensing element is configured to output a first current pulse in response to a first charged particle arriving at the charged particle sensing element, wherein the first current pulse triggers the first SSCCD to the on state;
in response to the first SSCCD being triggered to the on state, causing the first signal detection cell to conduct the first current pulse to an output of the first SSCCD, and
receiving an enabling signal at a second signal detection cell comprising a second SSCCD, the enabling signal being based on the first current pulse, wherein
enabling, by the enabling signal, a second SSCCD of the second signal detection cell to be put into an on state in which the second SSCCD can conduct current from the charged particle sensing element.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes can be made without departing from the scope thereof. For example, a charged particle inspection system may be but one example of a charged particle beam system consistent with embodiments of the present disclosure.

1. A non-transitory computer-readable medium that stores a set of instructions that is executable by at least one processor of an apparatus to cause the apparatus to perform a method comprising:
enabling a first solid state current controlling device (SSCCD) of a first signal detection cell to be put into an on state in which the first SSCCD can conduct current from a charged particle sensing element of a charged particle counting detector;
outputting a first current pulse from the charged particle sensing element in response to a first charged particle arriving at the charged particle sensing element, wherein the first current pulse triggers the first SSCCD to the on state;
in response to the first SSCCD being triggered to the on state, conducting the first current pulse from an input to an output of the first SSCCD; and
receiving a second enabling signal at a second signal detection cell comprising a second SSCCD, the second enabling signal being based on the first current pulse,
wherein the second enabling signal enables the second SSCCD of the second signal detection cell to be put into the on state in which the second SSCCD can conduct current from the charged particle sensing element.

2. The non-transitory computer-readable medium of claim 1, wherein the first SSCCD or the second SSCCD comprises a thyristor.

3. The non-transitory computer-readable medium of claim 1, wherein enabling the first SSCCD of the first signal detection cell comprises closing an enabling switch to couple a first control gate of the first SSCCD to an anode of the first SSCCD.

4. The non-transitory computer-readable medium of claim 1, wherein the set of instructions that is executable by the at least one processor of the apparatus causes the apparatus to further perform:
in response to the first current pulse exceeding a threshold, beginning to conduct current by the first SSCCD.

5. The non-transitory computer-readable medium of claim 1, wherein the set of instructions that is executable by the at least one processor of the apparatus causes the apparatus to further perform:
in response to the first current pulse falling below a threshold, ceasing to conduct current by the first SSCCD.

6. The non-transitory computer-readable medium of claim 1, wherein the set of instructions that is executable by the at least one processor of the apparatus causes the apparatus to further perform:
generating an operating status output signal based on the first current pulse.

7. The non-transitory computer-readable medium of claim 6, wherein the set of instructions that is executable by the at least one processor of the apparatus causes the apparatus to further perform:
transmitting the operating status output signal to signal processing circuitry; and
detecting a charged particle arrival event at the signal processing circuitry based on the operating status output signal.

8. The non-transitory computer-readable medium of claim 6, wherein the set of instructions that is executable by the at least one processor of the apparatus causes the apparatus to further perform:
transmitting the operating status output signal to signal processing circuitry; and
counting a full cycle of charged particle arrival events at the signal processing circuitry based on the operating status output signal,
wherein a number of charged particle arrival events counted in the full cycle corresponds to a number of non-bypassed signal detection cells coupled to the output of the charged particle sensing element.

9. The non-transitory computer-readable medium of claim 1, wherein the set of instructions that is executable by the at least one processor of the apparatus causes the apparatus to further perform:
generating the second enabling signal based on the first current pulse.

10. The non-transitory computer-readable medium of claim 1, wherein the set of instructions that is executable by the at least one processor of the apparatus causes the apparatus to further perform:
generating a detection result signal at an analog signal output of the first signal detection cell; and
transmitting the detection result signal to signal processing circuitry.

11. The non-transitory computer-readable medium of claim 10, wherein the set of instructions that is executable by the at least one processor of the apparatus causes the apparatus to further perform:
processing energy level information of the detection result signal at the signal processing circuitry.

12. The non-transitory computer-readable medium of claim 10, wherein the set of instructions that is executable by the at least one processor of the apparatus causes the apparatus to further perform:
processing overflow information of the detection result signal at the signal processing circuitry.

13. The non-transitory computer-readable medium of claim 1, wherein the set of instructions that is executable by the at least one processor of the apparatus causes the apparatus to further perform:
resetting the first signal detection cell to an initial state,
wherein in the initial state, a first control gate of the first signal detection cell is configured to be enabled by a further enabling signal.

14. The non-transitory computer-readable medium of claim 1, wherein the set of instructions that is executable by the at least one processor of the apparatus causes the apparatus to further perform:
bypassing a third signal detection cell comprising a third SSCCD by a bypass circuit of the third signal detection cell,
wherein the bypass circuit is configured to cause signals to pass from an enabling signal input of the third signal detection cell to an enabling signal output of the third signal detection cell without enabling a third SSCCD of the third signal detection cell to be put into an on state in which the third SSCCD can conduct current from the charged particle sensing element.

15. A charged particle counting detector, comprising:
a charged particle sensing element configured to output a first current pulse in response to a first charged particle arriving at the charged particle sensing element;
a first signal detection cell comprising a first solid state current controlling device (SSCCD) that is configured a) to be enabled, by a first enabling signal, to be put into an on state in which the first SSCCD can conduct current from the charged particle sensing element, b) to be triggered to the on state by the first current pulse, and c) to conduct the first current pulse to an output of the first SSCCD in response to the first SSCCD being triggered to the on state; and
a second signal detection cell configured to receive a second enabling signal and comprising a second SSCCD that is configured to be enabled, by the second enabling signal, to be put into an on state in which the second SSCCD can conduct current from the charged particle sensing element.

16. The charged particle counting detector of claim 15, wherein the first SSCCD or the second SSCCD comprises a thyristor.

17. The charged particle counting detector of claim 15, the first SSCCD of the first signal detection cell is configured to be enabled by closing an enabling switch to couple a first control gate of the first SSCCD to an anode of the first SSCCD.

18. The charged particle counting detector of claim 15, the first signal detection cell is configured to receive the first enabling signal from a control unit.

19. The charged particle counting detector of claim 15, wherein the first SSCCD is configured to begin conducting current in response to the first current pulse exceeding a threshold.

20. A signal detection cell for a charged particle counting detector, comprising:
an enable signal input configured to receive a first enabling signal to enable the signal detection cell to detect a charged particle arrival signal from a charged particle sensing element;
an analog signal input configured to receive the charged particle arrival signal from the charged particle sensing element;
an operation status output configured to output an operation status signal based on the charged particle arrival signal; and
an enable signal output configured to output a second enabling signal to be provided to a further signal detection cell based on the charged particle arrival signal.
